(19) United States
(12) Patent Application Publication
(10) Pub. No.: US 2005/0016658 A1
(43) Pub. Date: Jan. 27, 2005

(54) Composite coatings for ground wall insulation in motors, method of manufacture thereof and articles derived therefrom

(76) Inventors: Thangavelu Asokan, Bangalore (IN); George Gao, Round Rock, TX (US); Rajesh Ghosh, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 10/627,480

(22) Filed: Jul. 24, 2003

(51) Int. Cl. H01B 13/06

(52) U.S. Cl. 156/53; 174/102 R

(57) ABSTRACT

An article comprises a bobbin wire; an electrically insulating backing disposed upon the bobbin wire; a mica paper disposed upon the electrically insulating backing and wound around the backing; and a silicone coating disposed upon the electrically insulating backing. A method of manufacturing an article comprises disposing an electrically insulating backing upon a bobbin wire; disposing mica paper upon the electrically insulating backing; and coating the mica paper with a silicone coating.

### BACKGROUND

This disclosure relates to composite coatings for ground wall insulation in motors, methods of manufacture thereof and articles derived therefrom.

In electromagnetic devices containing soft magnetic materials, the magnetic permeability and core loss characteristics are important properties of soft magnetic materials. Magnetic permeability is a measure of the ease with which a magnetic substance may be magnetized and is an indication of the ability of the material to carry a magnetic flux. Magnetic permeability is defined as the ratio of the induced magnetic flux to the magnetizing force or the magnetic field intensity. The exposure of a magnetic material to a rapidly varying field results in an energy loss in the magnetic core of the material; this energy loss is known as the core loss. Core loss is divided into two categories, hysteresis loss and eddy current loss. The hysteresis loss results from the expenditure of energy to overcome the retained magnetic forces in the magnetic core. The eddy current loss results from the flow of electric currents within the magnetic core induced by the changing flux.

Electromagnetic devices generally use a magnetic core made from laminated structures. Laminated cores are made by stacking thin ferrous sheets which are oriented parallel to the magnetic field to provide low reluctance. The sheets may be coated to provide insulation and prevent current from circulating between sheets. Such insulation results in a reduction in the eddy current loss. In addition, the application of laminated cores is limited by the need to carry magnetic flux in the plane of the sheet to avoid excessive eddy current losses.

Some of the problems of utilizing laminated cores in electrical devices such as motors have been overcome by utilizing moldable soft magnetic composites. While soft magnetic composites provide a high copper fill factor and can reduce or even eliminate the air column within the motor they suffer from a number of drawbacks related to high temperature performance. It is therefore desirable to produce electromagnetic devices having high permeability and low core loss characteristics in a cost effective manner. It is additionally desirable to produce electromagnetic devices that can operate efficiently at elevated temperatures.

### BRIEF DESCRIPTION OF THE INVENTION

An article comprises a bobbin wire; an electrically insulating backing disposed upon the bobbin wire; a mica paper disposed upon the electrically insulating backing and wound around the backing; and a silicone coating disposed upon the electrically insulating backing.

In one embodiment, an article comprises a bobbin wire; an electrically insulating backing disposed upon the bobbin wire; a mica paper disposed upon the electrically insulating backing and wound around the backing; a silicone coating disposed upon the electrically insulating backing; and a plurality of ferromagnetic particles disposed upon the silicone coating.

In another embodiment, a method of manufacturing an article comprises disposing an electrically insulating backing upon a bobbin; disposing mica paper upon the electrically insulating backing; and coating the mica paper with a silicone coating.

In another embodiment, a method of manufacturing an article comprises disposing an electrically insulating backing upon a bobbin wire; disposing mica paper upon the electrically insulating backing; coating the mica paper with a silicone coating to form an insulated bobbin wire; compacting the insulated bobbin and a plurality of ferromagnetic particles in a mold at a pressure of 250 to about 1500 MPa.

### BRIEF DESCRIPTION OF DRAWINGS

FIG. 1 is a schematic diagram showing the insulation layer disposed upon the wires of a winding;

FIG. 2 is a photograph of showing the wires 12 of the winding in a mold filled with coated ferromagnetic particles prior to compaction;

FIGS. 3(a) and 3(b) are graphical representations of the breakdown voltage for glass and (PAI+PEI) enamel respectively;

FIG. 4 shows a typical cross section of the compressed bobbin;

FIG. 5 is a photograph showing the damaged surface of the insulation on the wire;

FIG. 6 is a depiction of the breakdown voltages of the different SILOX grades as a function of the heat treatment temperature;

FIG. 7 is a graphical representation of the breakdown voltage (BDV) versus compaction pressure;

FIG. 8 is an optical micrograph of the bobbin after being subjected to compression when surrounded by ferromagnetic particles;

FIG. 9 is a graphical representation of deformation and elongation versus compaction pressure;

FIG. 10 is a Weibull plot depicting the effect of insulation thickness on breakdown voltage;

FIG. 11 is a bar chart showing breakdown voltage as a function of pre-compaction pressure;

FIG. 12 is a graphical representation of the flake mixture as a function of breakdown voltage;

FIG. 13 is a micrograph of showing a manner of estimating deformation by using the dimensions of the bobbin cross-section;

FIG. 14 is a graphical representation of the flake mixture as a function of deformation;

FIG. 15 is a schematic diagram illustrating the different configuration used for electrical measurements on the insulated wires (bobbins);

FIGS. 16(a) and (b) are graphical representations of the impulse and power frequency voltages respectively versus temperature;

FIGS. 17(a) and (b) is a graphical representation of the impulse and power frequency voltages respectively versus temperature;

FIGS. 18(a) and (b) is a graphical representation of the inter-turn insulation of the PEI-PAI enamel wire under impulse and power frequency voltages respectively;

FIGS. 19(a) and (b) is a graphical representation of the ground wall insulation under impulse and AC voltages;

FIG. 20 shows and optical micrograph of fused glass and enamel wire bobbins compressed at 100 ksi (690 MPa) in a 3 mm soft magnetic flakes;

### DETAILED DESCRIPTION OF PREFERRED EMBODIMENTS

Disclosed herein is an insulation layer that may be used to protect windings (preformed windings of magnet wires which are also termed bobbin wires) in the stators of electrical devices such as motors when the stators are manufactured using soft magnetic composites. Disclosed herein too is a method for applying the insulation layer on to a winding that may be utilized in electrical devices. In one embodiment, the insulation layer is disposed on the windings in the stators of electrical devices to afford protection for the windings. The insulation layer generally comprises a ground wall insulation tape that is coated with a curable polymeric resin. In an exemplary embodiment, the ground wall insulation tape comprises a mica paper layer disposed upon a woven fibrous backing (or) polymeric film backing layer while the curable polymeric resin comprises a silicone polymer. The insulation layer advantageously has a compressive strength and hardness effective to withstand a compressive force of about 250 to about 1500 mega-Pascals (MPa) applied during the compaction of the soft magnetic composite around the winding.

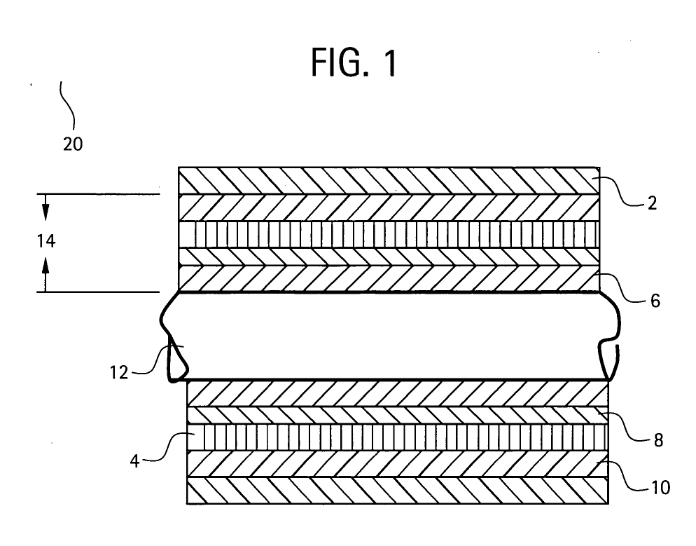

As may be seen in FIG. 1, in the application of the ground wall insulation tape 14 to the winding, the fibrous backing 6 is first disposed upon the winding wire(s) 12 of the winding (as noted above, these are also termed bobbin wires). An optional polymeric resinous film 8 is then disposed upon and in intimate contact with the fibrous backing 6. The mica paper 4 is disposed upon and in intimate contact with the polymeric resinous film 8. An optional corona treated polymeric film layer 4 may then be disposed upon and in intimate contact with the polymeric resinous film 8. In place of polymeric film (4), a woven fiber may also be used (i.e., double sided backing for the mica paper). The curable coating 2 is then applied upon the ground wall insulation tape 14 to form the insulation layer 20.

In one embodiment, the ground wall insulation tape 14 comprises a mica paper layer disposed directly upon a fibrous backing layer after application to the winding. In another embodiment, the ground wall insulation tape comprises a mica paper disposed upon a polymeric resinous film after application to the winding. The surface of the polymeric resinous film opposite the mica paper is then disposed upon a surface of the. Prior to the application to the winding, the fibrous backing is preferably a separate entity from the polymeric resinous film and the mica paper.

As stated above, the ground wall insulation tape comprises mica paper. Mica paper generally comprises phlogopite (K Mg₃ AlSi₃ O₁₀ (OH)₂) or muscovite (K₂ Al₄ [Si₆ Al₂ O₂₀] (OH, F)₄). This mica (i.e., phlogopite or muscovite or both) is subjected to a process in which it is heated to an elevated temperature of about 500 to about 850° C. This heat causes the mica crystal to partially dehydrate and release a portion of the water, which is bonded naturally in the crystal. When this occurs, the mica partially exfoliates, resulting in smaller particles. The heated mica is then quenched in a mild alkaline solution, cooled, drained, and subjected to a weak sulfuric acid solution. The chemical reaction between the caustic and the acid generates a gas between the laminae, which causes the mica to expand greatly. The mica is then ground to produce small particles. The mica is screened in the presence of large amounts of water on separating screens to select the desired particle size distribution to produce the paper desired. This “pulp” is then transferred to a specially modified paper machine for sheet forming and drying. The Van der Waals' forces between the crystal surfaces of the mica platelets in close proximity hold the layer together.

The mica paper can have a thickness of about 5 μm to about 100 μm. Within this range it is generally desirable to have a thickness of greater than or equal to about 10, preferably greater than or equal to about 12, and more preferably greater than or equal to about 15 μm. Also desirable within this range is an amount of less than or equal to about 90, preferably less than or equal to about 80, and more preferably 75 μm. An example of commercially available Mica paper is SAMICA 4200® from US Samica. Other fillers may also be used in conjunction with the mica to form the mica paper. Examples of such fillers include glasses such as silica, alumina, borosilicate glass, or the like, or combinations comprising at least one of the foregoing. Suitable examples of a mica glass layer that may be used is FIROX®, commercially available from Cogebi, NOVOBOND® S, SX, SA, and POLYMICA®, commercially available from Krempel.

The mica tape also generally comprises an adhesive on the surface that is disposed upon the fibrous backing or the optional polymeric resinous film. The term adhesive as used herein means that the composition is formulated to have a glass transition temperature, surface energy, and/or other properties such that it exhibits some degree of tack at room temperature. Thus, the constituent polymers and/or copolymers of the composition generally will have a glass transition temperature of less than or equal to about 0° C. such that the mass of the composition is tacky at ambient temperatures and is thereby bondable under an applied pressure to a surface or other substrate.

Suitable adhesive formulations include film-forming materials such as a natural or synthetic rubber or elastomer, or other resin, plastic, or polymer exhibiting rubber-like properties of compliancy, resiliency or compression deflection, low compression set, flexibility, and an ability to recover after deformation. Examples of such materials include styrene-butadienes, styrene-isoprenes, polybutadienes, polyisobutylenes, polyurethanes, silicones, fluorosilicones and other fluoropolymers, chlorosulfonates, butyls, neoprenes, nitrites, polyisoprenes, plasticized nylons, polyesters, polyvinyl ethers, polyvinyl acetates, polyisobutylenes, ethylene vinyl acetates, polyolefins, and polyvinyl chlorides, copolymer rubbers such as ethylene-propylene (EPR), ethylene-propylene-diene monomer (EPDM), styrene-isoprene-styrene (SIS), styrene-butadiene-styrene (SBS), nitrile-butadienes (NBR) and styrene-butadienes (SBR), blends such as ethylene propylene diene monomer (EPDM), EPR, or NBR, and mixtures, blends, and copolymers thereof.

These materials may be compounded with a tackifier, which may be a resin such as glyceryl esters of hydrogenated resins, thermoplastic terpene resins, petroleum hydrocarbon resins, coumarone-indene resins, synthetic phenol resins, low molecular weight polybutenes, or a tackifying silicone. Additional fillers and additives may be included in the adhesive composition depending upon the requirements of the particular application, for example conventional wetting agents or surfactants, piμments, dyes, and other colorants, opacifying agents, anti-foaming agents, anti-static agents, coupling agents such as titanates, chain extending oils, lubricants, stabilizers, emulsifiers, antioxidants, thickeners, and/or flame retardants such as aluminum trihydrate, antimony trioxide, metal oxides and salts, intercalated graphite particles, phosphate esters, brominated diphenyl compounds such as decabromodiphenyl oxide, borates, phosphates, halogenated compounds, glass, silica, silicates, and mica.

For thermal applications at temperatures of less than or equal to about 200° C., it is generally desirable to use adhesives that comprise hydrocarbon polymers, while for applications wherein the temperature may exceed 200° C., it is generally desirable to use adhesives that comprise silicone polymers. The preferred adhesive is a silicone adhesive that can withstand temperatures of about 150 to about 300° C.

The ground wall insulation tape 14 may optionally comprise a polymeric resinous film 8. The polymeric resinous film 8 generally comprises a polymeric resin, which may be a thermoplastic resin, a thermosetting resin or a combination of a thermoplastic resin with a thermosetting resin. The polymeric resin may be a homopolymer, a copolymer such as a star block copolymer, a graft copolymer, an alternating block copolymer or a random copolymer, ionomers, dendrimers, or a combination comprising at least one of the foregoing polymeric resins.

Examples of thermoplastic resins include polyacetal, polyacrylic, styrene-acrylonitrile, acrylonitrile-butadiene-styrene (ABS), polycarbonates, polystyrenes, polyethylene, polypropylenes, polyesters such as polyethylene terephthalate, polybutylene terephthalate, polyamides such as nylon 6, nylon 6,6, nylon 6,10, nylon 6,12, nylon 11 or nylon 12, polyamideimides, polyimides, polyarylates, polyurethanes, ethylene propylene diene rubber (EPR), ethylene propylene diene monomer (EPDM), polyarylsulfone, polyethersulfone, polyphenylene sulfide, polyvinyl chloride, polysulfone, polyetherimide, polyesterimide, polytetrafluoroethylene, fluorinated ethylene propylene, perfluoroalkoxy, polychlorotrifluoroethylene, polyvinylidene fluoride, polyvinyl fluoride, polyetherketone, polyether etherketone, polyether ketone ketone, or the like, or combinations comprising at least one of the foregoing thermoplastic resins.

Examples of blends of thermoplastic resins include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, stytene-maleic anhydride/acrylonitrile-butadiene-styrene, polyether etherketone/polyethersulfone, polyethylene/nylon, polyethylene/polyacetal, or the like, or combinations comprising at least one of the foregoing blends of thermoplastic resins.

Examples of polymeric thermosetting resins include polyurethanes, natural rubber, synthetic rubber, epoxy, phenolic, polyesters, polyamides, silicones, or the like, or combinations comprising at least one of the foregoing thermosetting resins. Blends of thermosetting resins can also be utilized. The preferred polymeric resin is polyimide, polyesterimide or polyamideimide. A suitable example of the preferred polymeric resin in commercially available form is the polyimide film KAPTON® from DuPont.

The polymeric resin or resin blend is generally used in amount of greater than or equal to about 10 weight percent (wt %) based on the total weight of the polymeric resinous film. If additional additives such as fillers are used, it is generally desirable to have the polymeric resin or resin blend in an amount of greater than or equal to about 20, preferably greater or equal to about 30, more preferably greater than or equal to about 40 wt % of the total weight of the polymeric resinous film. If additional additives such as fillers are used, the polymeric resins or resin blend is generally present in amounts of less than or equal to about 99, preferably less than or equal to about 85, more preferably less than or equal to about 80 wt % of the total weight of the polymeric resinous film.

The polymeric resinous film of the ground wall insulation tape may optionally comprise fillers. It is generally desirable for the fillers to be non-electrically conductive. The fillers may have shapes whose dimensionalities are defined by integers, e.g., the particles are either 1, 2 or3-dimensional in shape. They may also have shapes whose dimensionalities are not defined by integers (e.g., they may exist in the form of fractals). The fillers may exist in the form of spheres, flakes, fibers, whiskers, or the like, or combinations comprising at least one of the foregoing forms. These fillers may have cross-sectional geometries that may be circular, ellipsoidal, triangular, rectangular, polygonal, or combinations comprising at least one of the foregoing geometries. The particles as commercially available may exist in the form of aggregates or agglomerates. An aggregate comprises more than one filler particle in physical contact with one another, while an agglomerate comprises more than one aggregate in physical contact with one another.

Examples of such fillers include those described in “Plastic Additives Handbook, 5^{th} Edition” Hans Zweifel, Ed, Carl Hanser Verlag Publishers, Munich, 2001. Examples of suitable fibrous fillers include short inorganic fibers, including processed mineral fibers such as those derived from blends comprising at least one of aluminum silicates, aluminum oxides, magnesium oxides, and calcium sulfate hemihydrate, boron fibers, ceramic fibers such as silicon carbide, and fibers from mixed oxides of aluminum, boron and silicon sold under the trade name NEXTEL® by 3M Co., St. Paul, Minn., USA. Also included among fibrous fillers are single crystal fibers or “whiskers” including silicon carbide, alumina, boron carbide, iron, nickel, copper. Fibrous fillers such as glass fibers, basalt fibers, including textile glass fibers and quartz may also be included.

Also included are natural organic fibers including wood flour obtained by pulverizing wood, and fibrous products such as cellulose, cotton, sisal, jute, cloth, hemp cloth, felt, and natural cellulosic fabrics such as Kraft paper, cotton paper and glass fiber containing paper, starch, cork flour, lignin, ground nut shells, corn, rice grain husks and mixtures comprising at least one of the foregoing.

In addition, organic reinforcing fibrous fillers and synthetic reinforcing fibers may be used. This includes organic polymers capable of forming fibers such as polyethylene terephthalate, polybutylene terephthalate and other polyesters, polyarylates, polyethylene, polyvinylalcohol, polytetrafluoroethylene, acrylic resins, high tenacity fibers with high thermal stability including aromatic polyamides, polyaramid fibers such as those commercially available from DuPont under the trade name KEVLAR®, polybenzimidazole, polyimide fibers such as those available from Dow Chemical Co. under the trade names POLYIMIDE 2080® and PBZ® fiber, polyphenylene sulfide, polyether ether ketone, polyimide, polybenzoxazole, aromatic polyimides or polyetherimides, and the like. Combinations of any of the foregoing fibers may also be used.

Such reinforcing fillers may be provided in the form of monofilament or multifilament fibers and can be used either alone or in combination with other types of fiber, through, for example, co-weaving or core/sheath, side-by-side, orange-type or matrix and fibril constructions, or by other methods of fiber manufacture. Typical cowoven structures include glass fiber-carbon fiber, carbon fiber-aromatic polyimide (aramid) fiber, and aromatic polyimide fiber-glass fiber. Fibrous fillers may be supplied in the form of, for example, rovings, woven fibrous reinforcements, such as 0-90 degree fabrics, non-woven fibrous reinforcements such as continuous strand mat, chopped strand mat, tissues, papers and felts and 3-dimensionally woven reinforcements, performs and braids.

In one embodiment, glass fibers are used in the polymeric resinous film. Useful glass fibers can be formed from any type of fiberizable glass composition and include those prepared from fiberizable glass compositions commonly known as “E-glass,” “A-glass,” “C-glass,” “D-glass,” “R-glass,” “S-glass,” as well as E-glass derivatives that are fluorine-free and/or boron-free. Most reinforcement mats comprise glass fibers formed from E-glass

Commercially produced glass fibers generally having nominal filament diameters of about 4.0 to about 35.0 micrometers, and most commonly produced E-glass fibers having nominal filament diameters of about 9.0 to about 30.0 micrometers may be included. The filaments are made by standard processes, e.g., by steam or air blowing, flame blowing, and mechanical pulling. The preferred filaments for plastics reinforcement are made by mechanical pulling. Use of non-round fiber cross section is also possible. The glass fibers may be sized or unsized. Sized glass fibers are conventionally coated on at least a portion of their surfaces with a sizing composition selected for compatibility with the polymeric matrix material. The sizing composition facilitates wet-out and wet-through of the matrix material upon the fiber strands and assists in attaining desired physical properties in the composite.

The glass fibers are preferably glass strands that have been sized. In preparing the glass fibers, a number of filaments can be formed simultaneously, sized with the coating agent and then bundled into what is called a strand. Alternatively the strand itself may be first formed of filaments and then sized. The amount of sizing employed is generally that amount which is sufficient to bind the glass filaments into a continuous strand and ranges from about 0.1 to about 5 wt %, and more typically ranges from about 0.1 to 2 wt % based on the weight of the glass fibers. Generally, this may be about 1.0 wt % based on the weight of the glass filament. Glass fibers in the form of chopped strands about one-fourth inch long or less and preferably about one-eighth inch long may also be used. They may also be longer than about one-fourth inch in length if desired.

When filler is used, it is generally used in amount of about 1 to about 70 weight percent (wt %) based on the total weight of the polymer layer. Within this range, it is generally desirable to have the filler in an amount of greater than or equal to about 5, preferably greater or equal to about 7, more preferably greater than or equal to about 10 wt % of the total weight of the polymer layer. Also desirable within this range, is a filler in amounts less than or equal to about 60, preferably less than or equal to about 50, more preferably less than or equal to about 40 wt % of the total weight of the polymer layer.

The polymeric resinous film may have a thickness of about 1 to about 250 micrometers (μm). Within this range, it is generally desirable to have a thickness greater than or equal to about 5, preferably greater than or equal to about 10, and more preferably greater than or equal to about 50 μm. Also desirable within this range is an amount of less than or equal to about 250, preferably less than or equal to about 200, and more preferably less than or equal to about 150 μm. The most preferred thickness is about 100 μm.

As stated above, the polymeric resinous film of the ground wall insulation tape is disposed upon a fibrous backing layer. It is desirable for the backing to be non-conductive. The fibrous backing layer may be manufactured from glass. Useful glass fibers can be formed from any type of fiberizable glass composition and include those prepared from fiberizable glass compositions such as “E-glass,” “A-glass,” “C-glass,” “D-glass,” “R-glass,” “S-glass,” as well as E-glass derivatives that are fluorine-free and/or boron-free. Most fibrous backing layers comprise glass fibers formed from E-glass. Other commonly used fibrous backings include those manufactured from polyethylene terephthalate, polybutylene terephthalate and other polyesters, polyarylates, polyethylenes such as SPECTRA®, polyvinylalcohol, polytetrafluoroethylene, acrylic resins, high tenacity fibers with high thermal stability including aromatic polyamides, polyaramid fibers such as those commercially available from DuPont under the trade name KEVLAR®, polybenzimidazole, polyimide fibers such as those available from Dow Chemical Co. under the trade names POLYIMIDE 2080® and PBZ® fiber, polyphenylene sulfide, polyether ether ketone, polyimide, polybenzoxazole, aromatic polyimides or polyetherimides, and the like. Combinations of any of the foregoing fibers may also be used.

It is generally desirable for the fibrous backing to have a fiber thickness of about 2 to about 100 μm. Within this range, it is generally desirable to have a fiber thickness of greater than or equal to about 5, preferably greater than or equal to about 10, and more preferably greater than or equal to about 20 μm. It is also generally desirable to have a fiber thickness of less than or equal to about 95, preferably less than or equal to about 90, and more preferably less than or equal to about 85 μm. It is generally desirable for the fibers in the braid to have a braid angle (i.e., the angle between the fibers in the braid) of about 20 to about 90 degrees. The preferred braid angle is an amount of about 30 to about 75 degrees.

As stated above, the insulation layer comprises a curable polymeric resin that is disposed upon the ground wall insulation layer in the form of a coating. The curable polymeric resin is one that is capable of withstanding elevated temperatures of about 100 to about 350° C. during the course of operation of the electrical device. Further it is desirable for the curable polymeric resin to be able to withstand the pressures imposed upon the SMC during compaction without any rupture or damage. The curable polymeric resin coating is preferably one that comprises a reactive functionality that can undergo crosslinking upon the application of heat or radiation to the coating. Examples of such curable polymeric resins include styrene-butadienes, styrene-isoprenes, polybutadienes, polyisobutylenes, polyurethanes, silicones, fluorosilicones and other fluoropolymers, chlorosulfonates, butyls, neoprenes, nitrites, polyisoprenes, plasticized nylons, polyesters, polyvinyl ethers, polyvinyl acetates, polyisobutylenes, ethylene vinyl acetates, polyolefins, and polyvinyl chlorides, copolymer rubbers such as ethylene-propylene (EPR), ethylene-propylene-diene monomer (EPDM), styrene-isoprene-styrene (SIS), styrene-butadiene-styrene (SBS), nitrile-butadienes (NBR) and styrene-butadienes (SBR), blends such as ethylene propylene diene monomer (EPDM), EPR, or NBR, and mixtures, blends, and copolymers thereof.

These polymeric resins may be compounded with a tackifier, which may be a resin such as glyceryl esters of hydrogenated resins, thermoplastic terpene resins, petroleum hydrocarbon resins, coumarone-indene resins, synthetic phenol resins, low molecular weight polybutenes, or a tackifying silicone. Additional fillers and additives may be included in the polymeric resin depending upon the amounts of pressure to be applied during the compaction, for example conventional wetting agents or surfactants, piμments, dyes, and other colorants, opacifying agents, anti-foaming agents, anti-static agents, coupling agents such as titanates, chain extending oils, lubricants, stabilizers, emulsifiers, antioxidants, thickeners, and/or flame retardants such as aluminum trihydrate, antimony trioxide, metal oxides and salts, intercalated graphite particles, phosphate esters, brominated diphenyl compounds such as decabromodiphenyl oxide, borates, phosphates, halogenated compounds, glass, silica, silicates, and mica.

It is generally desirable for the curable polymeric resin coating to comprise a functional silicone polymer. The silicone polymer is preferably one that has reactive functionalities such as epoxides, vinyl, vinylether, propenylether, epoxides carboxylic, ester, acrylic, alkoxy, or the like, or combinations comprising at least one of the foregoing reactive functionalities. The silicone polymer may also be copolymerized with other suitable polymers that can withstand the aforementioned elevated temperatures. Suitable examples of such polymers are polyimides, polyetherimides, polyamideimides, polyether ether ketones, polyether ketone ketones, polysulfones, polypropylene ethers, polysulfides, or the like, or combinations comprising at least one of the foregoing polymers.

A preferred curable polymeric resin coating comprises epoxy-functionalized siloxane polymers. Preferred epoxy-functionalized siloxane polymers include β-(3,4-epoxycyclohexyl)ethyltrimethoxy silane, dialkylepoxysiloxy-chain-stopped polydialkyl-alkylepoxysiloxane copolymers (such as the materials sold as UV9315 and UV9400 by General Electric Silicones), and trialkylsiloxy-chain-stopped polydialkyl-alkylepoxysiloxane copolymers (such the material sold as UV9300 by General Electric Silicones), epoxy functional siloxane resin (such as the material sold as UV9430 by General Electric Silicones), blends of epoxy functional siloxane copolymers with vinyl and/or propenyl ethers. Another preferred curable polymeric resin coating is SILOX CE77 commercially available from Nippon Pelnox Corporation.

As stated above, the curable polymeric resin coating may advantageously comprise fillers such as those mentioned above. A preferred filler is fumed silica. It is generally desirable for the fillers utilized in the curable polymeric resin coating to be treated with a silane-coupling agent such as tetramethylchlorosilane, hexadimethylsilazane, or the like, or combinations comprising at least one of the foregoing silane coupling agents. The silane-coupling agents generally enhances compatibility of the filler with the curable polymeric resin and improves the mechanical properties of the curable polymeric resin.

The fillers are generally used in amount of about 1 to about 70 weight percent (wt %) based on the total weight of the curable polymeric resin prior to curing. Within this range, it is generally desirable to have the filler in an amount of greater than or equal to about 5, preferably greater or equal to about 7, more preferably greater than or equal to about 10 wt % of the total weight of the curable polymeric resin prior to curing. Also desirable within this range, is a filler in amounts less than or equal to about 60, preferably less than or equal to about 50, more preferably less than or equal to about 40 wt % of the total weight of the curable polymeric resin prior to curing.

The curable polymeric resin coating 2 generally has an average thickness of about 10 to about 2,000 μm. Within this range it is generally desirable to have a thickness of greater than or equal to about 15, preferably greater than or equal to about 20, and more preferably greater than or equal to about 20 μm. Also desirable within this range is a cured coating thickness of less than or equal to about 1,500, preferably less than or equal to about 1,200, and more preferably less than or equal to about 1,000 μm. The curable polymeric resin coating 2 is then heated to a temperature of about 100 to about 200° C. for a period of about 15 minutes to about 10 hours. The preferred curing temperature is 175° C. and the preferred curing time is 30 minutes.

As stated above, in the application of the ground wall insulation tape 14 to the winding, the fibrous backing 6 is first wound around the wire(s) 12 of the winding. The optional polymeric resinous film 8 may then be wound round the wire(s) 12 such that it is disposed upon and in intimate contact with the fibrous backing. The mica paper 4 is then wound round the wire(s) 12 such that it is disposed upon and in intimate contact with the polymeric resinous film. An optional corona treated polymeric layer 4 may then be wound round the wire(s) 12 if desired, such that it is disposed upon and in intimate contact with the polymeric resinous film 8. The curable polymeric resin coating 2 is then applied upon the ground wall insulation tape 14 to form the insulation layer 20.

In wrapping the wires of the winding with the fibrous backing, the polymeric resinous film, or the mica paper, it is desirable for each successive turn of the backing, the film or the paper to overlap with the previous turn in an amount of about 10 to about 90%. The overlap as defined herein is the amount of area of any one given turn that is covered by any succeeding turn. Within the aforementioned range it is generally desirable to have an overlap of greater than or equal to about 15, preferably greater than or equal to about 20, and more preferably greater than or equal to about 25%. Also desirable within this range is an overlap of less than or equal to about 85, preferably less than or equal to about 80, and more preferably less than or equal to about 78%. The preferred value of overlap is about 50 to about 75%.

After the application of the insulation layer to the wires of the winding, the insulated winding is placed in a mold and covered with iron flakes and compacted to form the soft magnetic composite. The ferromagnetic particles are particles of iron or iron alloys such as iron-silicon (Fe—Si), iron-aluminum (Fe—Al), iron-silicon-aluminum (Fe—Si—Al), iron-nickel (Fe—Ni), iron-cobalt (Fe—Co), iron-cobalt-nickel (Fe—Co—Ni), or the like, or combinations comprising at least one the foregoing iron alloys. In addition, the aforementioned alloys may comprise phosphorus and boron. While iron alloys generally have a higher permeability and lower core losses when compared with pure iron, pure iron provides a higher induction (high B), is softer, is easier to compact to high density and is lower in cost.

In one embodiment, the ferromagnetic particles derived from iron alloys are particles of carbon steel comprising carbon and manganese, preferably 0.9 atomic percent (at %) carbon (C) and 1 at % manganese; tungsten steel comprising carbon, chromium and tungsten preferably 0.7 at % C., 0.3 at % chromium (Cr), and 6 at % tungsten (W); 3.5% Cr steel comprising C and Cr, preferably 0.9 at % C and 0.35 at % Cr; 15% Co steel comprising C, Cr, molybdenum (Mo) and Co, preferably 1.9 at % C, 7 at % Cr, 0.5 at % Mo, and 15 at % Co; KS steel comprising C, Cr, W and Co, preferably 0.9 at % C, 3 at % Cr, 4 at % W, and 35 at % Co; MT Steel comprising C and aluminum (Al), preferably 2.0 at % C, and 8.0 at % Al; Vicalloy comprising Co and vanadium (V), preferably 52 at % Co, and 14 at % V, MK Steel comprising Ni, Al, Co and Cu, comprising 16 at % Ni, 10 at % Al, 12 at % Co and 6 at % Cu; platinum (Pt)—Fe powder, Fe—Co comprising 55 at % Fe, and 45 at % Co, shock resisting tool steel comprising C, Mo, and Cr, preferably 0.5 at % C, 1.40 at % Mo, and 3.25 at % Cr; water atomized low carbon steel; or the like, or combinations comprising at least one of the foregoing alloys. The at % are based on the total atomic composition of the alloys. The preferred ferromagnetic particles are those obtained from high purity iron (100 at % Fe).

It is generally desirable for the ferromagnetic particles to have an average particle size as determined by the average mass radius of gyration of about 0.01 to about 25,000 micrometers (μm) prior to coating and compaction. Within the aforementioned range for average particle sizes, it is desirable to have an average particle size of greater than or equal to about 0.1, preferably greater than or equal to about 1, and more preferably greater than or equal to about 10 μm. Also desirable within this range is a particle size of less than or equal to about 24,000, preferably less than or equal to about 23,000, and more preferably less than or equal to about 22,000 μm.

If the ferromagnetic particles are fibrous, it is generally desirable to have an aspect ratio greater than or equal to about 2, preferably greater than or equal to about 10, preferably greater than or equal to about 50, and more preferably greater than or equal to about 100. It is generally desirable for the fibrous ferromagnetic particles to have an average length of about 3,000 to about 50,000 μm. Within this range, particles having average lengths of greater than or equal to about 4,000, preferably greater than or equal to about 5,000 μm may be used. Also desirable within this range, are average particle lengths of less than or equal to about 45,000, preferably less than or equal to about 40,000 μm. For fibrous particles, an average width of about 10 to about 2,000 μm may be used. Within this range, a width of greater than or equal to about 50, and more preferably greater than or equal to about 100 μm may be used. Also desirable within this range are widths of less than or equal to about 1,750, preferably less than or equal to about 1,500, and more preferably less than or equal to about 800 μm.

When platelet shaped particles are used, it is generally desirable to have an average thickness of 10 to about 4,000 μm. Within this range, the average thickness may be greater than or equal to about 50, and more preferably greater than or equal to about 100 μm may be used. Also desirable within this range are average thicknesses of less than or equal to about 3,750, preferably less than or equal to about 3,500, and more preferably less than or equal to about 3,000 μm.

The ferromagnetic particles used in the coated soft magnetic composite may be advantageously derived from a variety of sources. For example, where the source of ferromagnetic particles is a solid material, it could be rolled into sheets and the sheets could be slit. In another example, where the source of ferromagnetic particles is a wire, it can be rolled to deform the wire thereby reducing the cross-section of the wire and changing its shape from a round shape to a flat shape. The flattened wire can then be cut into flakes with the desired dimensions as indicated above. In another embodiment, the ferromagnetic particles can be made from molten ferromagnetic material.

The ferromagnetic particles may optionally be annealed prior to the application of a coating, thereby improving the magnetic properties of the particles and the composites derived therefrom. This annealing process is often referred to as a pre-annealing process. The ferromagnetic particles are generally pre-annealed prior to the application of the coating at temperatures of about 600 to about 1200° C., for a time period of about 15 to about 150 minutes. The preferred pre-annealing temperature is about 800° C. for as time period of about 60 minutes. The pre-annealing process can be performed in any protective atmosphere, such as, for example, argon, nitrogen, hydrogen, or combination comprising at least one of the foregoing atmospheres. In one embodiment, the pre-annealing process can be a “decarb” annealing process that is performed under a standard decarburizing atmosphere to reduce the carbon content in the particulates to less than or equal to about 0.05 weight percent (wt %), where the weight percents are based on the total weight of the composition. The decarb annealing process can reduce the carbon content to less than or equal to about 0.009 wt %, based on the total weight of the composition.

The ferromagnetic particles may also be optionally degreased using a solvent following which these particles may be cleaned of all metal oxides by using a dilute aqueous solution of an inorganic acid or an inorganic salt in water. Examples of solvents used for the degreasing are acetone, methyl ethyl ketone, toluene, alcohols such as methanol, ethanol, isopropanol, butanol, or the like, N, N dimethylformamide, hexane, or combinations comprising at least one of the foregoing solvents. The preferred solvent is acetone.

Examples of inorganic acids used for removing the oxides are hydrochloric acid, nitric acid, sulfuric acid, or the like, or combinations comprising at least one of the foregoing acids. The preferred acid is hydrochloric acid. Examples of inorganic salts are potassium nitrate, sodium chlorate, sodium bromate, or the like, or combinations comprising at least one of the foregoing inorganic salts. The preferred inorganic salt is potassium nitrate. It is generally desirable to have a solution comprising at least 0.1 to about 50 grams per liter (g/l) of the acid or salt in the water. Within this range, it is desirable to have an amount of greater than or equal to about 0.5 g/l. Also desirable within this range is an amount of less than or equal to about 25, preferably less than or equal to about 10 g/l.

Other additives such as oxidizing agents, surfactants, accelerators, and the like may also be optionally added to the aqueous solution to facilitate the cleaning of the ferromagnetic particles. Examples of organic oxidizing agents suitable for use in the aqueous solution include sodium m-nitrobenzene, nitrophenol, dinitrobenzene sulfonate, p-nitrobenzoic acid, nitrophenol nitroguanidine, nitrilloacetic acid, or the like, or combinations comprising at least one of the foregoing oxidizing agents. If organic oxidizers are used, it is desirable to use them in an amount of about 0.3 to about 10 g/l. Within this range, it is desirable to use an amount of greater than or equal to about 0.5 g/l. Also desirable within this range is an amount of less than or equal to about 2.5 g/l. Alternatively (or additionally), phosphoric acid may optionally be used in an amount of about 0.1 to about 5 g/l of the aqueous solution.

Examples of surfactants that may be used are sodium dodecyl benzyl sulfonate, lauryl sulfate, oxylated polyethers, ethoxylated polyethers, or the like, or combinations comprising at least one of the foregoing surfactants. Surfactants may generally be used in an amount of up to about 0.5 g/l of the aqueous solution. Within this range it is generally desirable to use the surfactants in an amount of greater than or equal to about 0.1 g/l of the aqueous solution.

The aqueous solution preferably has a temperature of up to about 60° C. Within this range it is generally desirable to use a solution temperature of greater than or equal to about 25° C. Also desirable within this range is a solution temperature of less than or equal to about 50° C. The treating step is preferably performed for a time period effective to permit the pH of the aqueous solution to come to equilibrium. When a pH change occurs, it is generally desirable to limit the pH change to about 20% of the initial pH value. The pH starting value of the solution depends on the detailed chemistry of the aqueous solution. However, in preferred aqueous solutions, the starting value of the pH is from about 5 to about 6. An exemplary pH change in the aqueous solution would involve an increase from a starting pH of about 5.5 to and end point pH of about 6.1 to about 6.5.

The inorganic particles may finally be rinsed with water to substantially remove all traces of the aqueous solution followed by drying the particles. The process optionally comprises a chromate, molybdate or nitrate rinse to inhibit subsequent oxidation of the coated particles.

The order of the annealing process and the cleaning process are reversible, i.e., either process may be carried out first as desired. In one exemplary embodiment, when high aspect ratio particles are used, the particles are first annealed to a temperature of 800° C. for a period of about 30 minutes to about 90 minutes.

It is generally desirable for the coating on the ferromagnetic particles to exhibit a number of properties, some of which are listed below. It is desirable for the coating to be as thin as possible while at the same time insulating adjacent particles from each other such that an insulation value of about 1 to about 20 milli-Ohm-centimeters is achieved in a part fabricated therefrom.

The coating preferably permits adjacent particles to bind together with sufficient force that a part made by compacting the ferromagnetic particles has sufficient transverse rupture strength so that good mechanical properties can be achieved via compaction without any simultaneous or subsequent sintering after compaction. As used above, “sufficient transverse rupture strength” should be construed as meaning a transverse rupture strength of about 8 kilo pounds per square inch (kpsi) to about 20 kpsi, and preferably at least about 15 kpsi as determined in accordance with the protocol of the American Society of Test Materials (ASTM) MPIF Standard 41.

The coating on the ferromagnetic particles should preferably exhibit lubricating properties, particularly during the initial stages of the compaction operations. This lubricating feature should optimally permit the particles to slip and slide by each other during compacting, thereby minimizing or eliminating point-to-point welding of the ferromagnetic particles. As a result, a denser, and hence stronger, soft magnetic article is obtained. Additionally, this lubricating property facilitates the ejection of the soft magnetic article from the die thereby decreasing overall manufacturing time and hence reducing manufacturing costs.

The coating on the ferromagnetic particles preferably has an electrical insulation value that does not substantially degrade when it is subjected to temperatures of greater than about 150° C. This permits use of soft magnetic articles made from ferromagnetic particles having polymeric resin coatings. The coating on the ferromagnetic particles should preferably be able to withstand relatively low temperatures, i.e. temperatures of about −60° C. to about 0° C., without degradation or embrittlement of the coating. Examples of such environments are found in colder climates and jet airplanes.

The preferred coating for the ferromagnetic particles is one derived from a silicone polymer or copolymer and that can withstand the elevated temperatures specified above. The coating has a thickness of about 0.1 to about 10 μm. Within this range, it is generally desirable to have a thickness of greater than or equal to about 0.2, preferably greater than or equal to about 0.4, and more preferably greater than or equal to about 0.5 μm. Also desirable within this range is an amount of less than or equal to about 7, preferably less than or equal to about 5, and more preferably less than or equal to about 3 μm. The coating has a viscosity of about 5 to about 10,000 centipoise. The preferred viscosity is about 300 to about 5,000 centipoise.

The coating for the ferromagnetic particles has a weight of less than or equal to about 0.2 wt %, based on the total weight of the soft magnetic composition. Within this range it is desirable for the coating to have a weight of greater than or equal to about 0.01, preferably greater than or equal to about 0.02, and more preferably greater than or equal to about 0.05 wt %, based on the total weight of the soft magnetic composition. Also desirable within this range is a coating having a weight of less than or equal to about 0.18, preferably less than or equal to about 0.15, and more preferably less than or equal to about 0.1 wt % based on the total weight of the soft magnetic composition.

In an exemplary embodiment, the coating covers at least 50% of the total surface area of the ferromagnetic particles. It is generally desirable to cover an amount of greater than or equal to about 60, preferably greater than or equal to about 70, and more preferably greater than or equal to about 90% of the total surface area of the ferromagnetic particles.

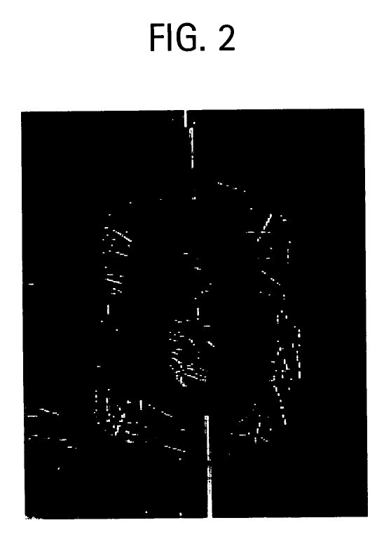

In the manufacture of a soft magnetic composite, the wires 12 of the winding having the insulation layer 20 disposed upon it are placed in a mold. The mold is the filled with a plurality of the coated ferromagnetic particles and subjected to compaction as shown in FIG. 2. Suitable examples of compaction techniques include uniaxial compaction, isostatic compaction, injection molding, extrusion, and hot isostatic pressing. The preferred mode of compaction is uniaxial compaction. A low compaction pressure results in a poor density of the compact. A high compaction pressure results in excessive residual stresses being induced in the compact. A suitable range for compaction pressure is about 250 MPa (mega-Pascals) to about 1,500 MPa. Within this range it is generally desirable to use a compaction pressure of greater than or equal to about 300, preferably greater than or equal to about 600, and more preferably greater than or equal to about 800 MPa. Also desirable within this range is a compaction pressure of less than or equal to about 1,300, preferably less than or equal to about 1,250, and more preferably less than or equal to about 1,200 MPa. The most preferred compaction pressure is about 1,100 MPa to about 1,200 MPa.

The density of the composite magnetic article is greater than about 90% of the true density of the ferromagnetic core material. It is generally desirable for the composite magnetic article to have a density of about 95 to about 97% of the true density of the ferromagnetic core material. Defects such as pores in the composite magnetic article affect the transport of magnetic flux and, therefore, reduce permeability. A decrease in the porosity increases the density of the compact and results in an increase in the permeability. During the compaction process, stresses are introduced into the coated ferromagnetic particles, which are subsequently relieved by subjecting the compact to a high temperature annealing treatment.

The articles derived by the aforementioned processes display a number of advantages. The coating provides an electrical insulation for individual ferromagnetic particles to reduce eddy current losses and may also serve as a binder or a lubricant. The desired properties in magnetic core articles made using magnetite coated ferromagnetic powders include high density, high permeability, low core losses, high transverse rupture strength, and suitability for compaction techniques. The properties of magnetic core articles, made using magnetite coatings provide significant advantages particularly at low frequency operation where low-core losses are particularly advantageous. Annealing the magnetic core article can result in increased permeability and lower core losses. Annealing relieves residual stresses caused by compaction of the encapsulated ferromagnetic powders. In addition, articles derived in this manner have a high copper fill factor and the air column is eliminated.

The advantageous properties of the soft magnetic composites permit them to be utilized in a variety of applications. Examples of such applications include automotive parts such as stators, rotors, actuators, armatures, solenoids and motors used in the engine compartment of gasoline or diesel motors. In addition, magnetic parts made from the coated ferromagnetic particles can be annealed at relatively high temperatures of about 250 to 450° C., so as to reduce stresses and consequently reduce core losses.

The following examples, which are meant to be exemplary, not limiting, illustrate compositions and methods of manufacturing of some of the various embodiments of the soft magnetic compositions and articles described herein.

### EXAMPLE 1

The following example was conducted to determine the ability of the wire to withstand the pressures developed during compaction.

All the magnetic wires were characterized for (i) insulation thickness, (ii) windability, (iii) breakdown voltage/strength, (iv) compressibility and (v) thermal withstand capability. The measurement method/s adopted are detailed below.

Insulation thickness: The diameter of the wire with and without insulation was measured. The former corresponds to the as-received magnet wire diameter and the later essentially corresponds to the diameter of the bare copper wire, obtained by removing the insulation either via thermal method, mechanical scratching or microscopy. Thermal method involves exposing the wire to 300° C. temperatures to make the insulation brittle. Subsequently, slight twisting/bending leads to insulation flaking off. In the case of mechanical scratching, the insulation was removed using a fine blade. Adequate care was taken to avoid scratching of the copper wire, which leads to error in the measurements. Microscopy (optical) is found to be more effective in the case of thin insulation. The insulation thickness of the magnet wires is evaluated using the following equation (1) below and the insulation thickness corresponds to a single wall:
Thickness=(diameter of as-received wire−diameter of bare copper wire)/2 (1)

Windability: Mandrel bending method was adopted to determine the windability of the magnet wires. In this test, the wires were wrapped (5 turns) on various diameters of mandrel and inspected for visual crack or any damage to the insulation. The diameter of the mandrel (d), represent the diameter of the wire. Depending upon the ability to withstand winding, the wires are classified as 1d (wire diameter), 2d (twice the wire diameter), 3d (thrice the wire diameter).

Breakdown voltage (BDV): Two types of method were adopted for the BDV measurements. The first method adopted is as per the National Electrical manufacturers association (NEMA) standard. About 40 cm long test wires were cut and the aluminum foil of 6 mm width was wrapped tightly to cover the insulation at five locations. A gap of 50 mm was maintained between the edges of each aluminum foil wrap. The voltage between the foil and the copper conductor was applied till breakdown. The rate of voltage rise (500 V/sec) and the tripping current of 5 mA were kept constant in all the cases. BDV tests were also conducted using iron powder instead of aluminum foil. Samples of˜15 cm long are cut and the center portion (min. 5 cm long) was immersed in the iron powder. The iron powder was used as ground and copper wire (i.e., one of the wire edge) was connected to HV terminal. The voltage was applied at 500 V/sec till breakdown. At least 6 samples were tested in each case and the average values are reported.

Compressibility: In this test, 15cm long test wire was placed in the cavity of a die and filled with iron powder (particulates). AC voltage of 200 volts was applied between the die and the copper (one of the wire edge). The pressure was then applied through the top punch of the die up to 130 ksi (896 MPa). Any insulation failure, during the application of pressure, was detectable through electrical breakdown. The pressure at which the insulation failure was recorded. The values reported in the report correspond to a minimum of 6 data.

The various samples tested are shown in Table 1 below. VonRoll Isola (VRI), Pearl, Doorvani, Showa were manufacturers of the respective samples shown in the table. The glass-based wires (as represented by samples 1 to 9 in Table 2) are prepared by wrapping the glass yarns on bare copper wire and bonded by using silicone resin. Single, double and triple (Samples 3 to 6) represent the number of glass layers provided on the wire. The difference between the wires 4 and 6 is the viscosity of the silicone resin. In the case of Sample 7, polyesterimide resin is used for bonding instead of silicone resin. The wires such as Sample 8 and 9 are prepared similar to that of the above wires; but the base wire is polyamideimide (PAI) enameled wire instead of bare copper wire. The enamel group wires (Samples 10 to 12) are prepared using enamel coating; but in the case of Samples 11 and 12 two layers of different enamel (PEI and PAI) coatings were applied. The wires (Samples 15 and 16) are coated with fluoropolymers such as polytetrafluoroethylene (PTFE) and ethylene tetrafluoroethylene (ETFE), respectively. Besides, the wrapped wires (Samples 13, 14 and 19 to 22) are made of wrapping the insulating paper/film such as Kapton, Mica and Mica-glass. In the case of Mica based film wrapped wires, thin insulating films such as Kapton, polyethylene (PE) or polyethylene terephthalate (PET) films are used for backing. The properties of all the wires are compared in the Table 1. It may be seen that the high temperature wire such as ceramic coated wire displays poor performance compared to other wires. The enamel wire (PEI+PAI) could withstand compressibility only up to 80 kilograms per square inch (ksi) (551.2 MPa) against the target value of 130 ksi (896 MPa).

TABLE 1

| | Insul. | Breakdown | Winding | |
|---|---|---|---|---|
| | thick | strength | NEMA- | Compressibility |
| Sample number | (mils) | (Volts/mil) | MW1000 | (ksi) |
| 1. Glass: Fused (VRI) | 3.8 | 225 ± 0.13 | 1d | ✓ 130 |
| 2. Glass: Fused (VRI) - thin Insulation | 3.0 | 253 ± 16 | 1d | ✓ 130 |
| 3. Glass: Silicone bond-single (Pearl) | 3.2 | 236 ± 12 | 1d | 106 ± 30 (fail) |
| 4. Glass: Silicone bond-double-A (Pearl) | 3.9 | 172 ± 5 | 1d | 90 ± 7 (fail) |
| 5. Glass: Silicon bond-Triple (Pearl) | 6.93 | 268 ± 16 | 1d | ✓ 130 |
| 6. Glass: Silicone bond-double-B (Pearl) | 4.65 | 456 ± 56 | 1d | ✓ 130 |
| 7. Glass: PEI bond-single (VRI) | 2.9 | 224 ± 5.7 | 1d | 15 ± 4 (fail) |
| 8. Glass - 2L + Enamel: Silicone bond (Pearl) | 5.2 | 1000 ± 14 | 1d | ✓ 130 |
| 9. Glass - 1L + Enamel: Silicone bond (Pearl) | 3.7 | 1465 ± 23 | 1d | ✓ 130 |
| 10. Enamel: Dual PEI + PAI (Pearl) | 1.6 | 3450 ± 65 | 1d | 82 ± 29 (fail) |
| 11. Enamel: Dual PEI + PAI (Pearl) - thin | 0.79 | 2145 ± 45 | 1d | 71 ± 22 (fail) |
| 12. Enamel: PAI (Pearl) | 1.55 | 1138 ± 58 | 1d | 88 ± 12 (fail) |
| 13. Kapton: 75% overlap (Pearl) | 4.6 | >2150 | 1d | ✓ 100 |
| 14. Kapton: 50% overlap (Pearl) | 2.9 | 2469 ± 39 | 1d | 60 ± 4 (fail) |
| 15. PTFE: coated (Doorvani) | 2.99 | 2074 ± 53 | 1d | 22 ± 4 (fail) |
| 16. ETFE: coated (Doorvani) | 6.61 | >1513 | 1d | 105 ± 17 (fail) |
| 17. Ceramic: Coated (Showa) | 7.1 | 178 ± 13 | 5d | 10 ± 0.5 (fail) |
| 18. Mica-Glass (VRI) | 3.1 | 210 ± 6 | 2d | ✓ 130 |
| 19. Semica taped + PE film (VRI) | 4.9 | 87 ± 6 | 2.5d | <50 (fail) |
| 20. Semica taped + Kapton film (VRI) | 4.5 | 402 ± 18 | 3d | 60 ± 15 (fail) |
| 21. Mica-Glass: Cablosam-SF650 (VRI) | 3.87 | 143 ± 8 | 5d | 30 ± 10 (fail) |
| 22. Mica-Glass: Cablosam-SF450/PET (VRI) | 4.97 | 453 ± 11 | 5d | 50 ± 10 (fail) |

VRI-Vonroll Isola, Switzerland; Pearl-Pearl Insulation, India; Showa-Showa electric wire, Japan; and Doorvani - Doorvani cables, India

Following the results from Table 2, several selected magnet wires are subjected to compression at 130 ksi (896 MPa) in SMC powder (except enamel wire) followed by heat treatment in nitrogen at elevated temperatures. The breakdown values of the selected wires at different temperatures (after compression) are included in Table 2 below. From Table 2 it may be seen that the performance of the wires such as Samples 3, 4 and 5 are found to be good at elevated temperatures. Breakdown voltages are shown in kilovolts.

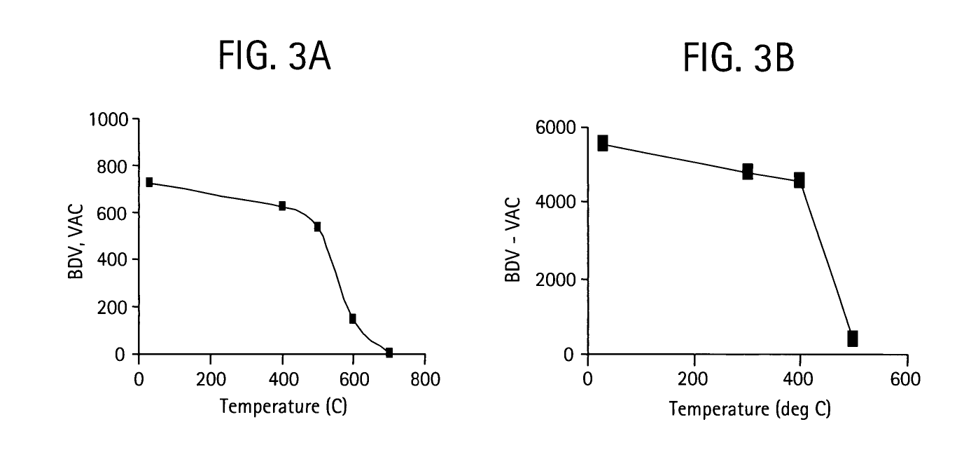

The electrical break down characteristics of the selected magnet wires from Table 2 as a function of temperature are shown in FIGS. 3(a) and 3(b), and indicates that fused glass wire (FIG. 3(a))is suitable for temperatures up to 500° C. where as the PEI-PAI enameled wire is suitable for temperatures up to 400° C. (FIGS. 3(b)). As can be seen from the graph that the breakdown voltages of these wires are found to reduce significantly above the respective withstand temperatures.

TABLE 2

| | | | BDV- | BDV |
|---|---|---|---|---|
| | Thick | BDV/ | kV | kV |
| Sample Number | (mils*) | mil | (400° C.) | (500° C.) |
| 1. Glass: Fused (VRI) | 3.81 ± 0.17 | 225 ± 0.13 | 620 ± 12 | 530 ± 21 |
| 2. Enamel: Dual PEI + PAI (Pearl) | 1.6 ± 0.02 | 3450 ± 65 | 4580 ± 85 | 382 ± 38 |
| 3. Glass: Silicone bond/double (Pearl) | 4.65 ± 0.19 | 456 ± 56 | 662 ± 23 | 610 ± 16 |
| 4. Glass: IL + Enamel-Silicone bond (Pearl) | 3.73 ± 0.45 | 1465 ± 23 | 654 ± 21 | 430 ± 15 |
| 5. Mica-Glass: VRI | 3.1 ± 0.14 | 210 ± 6 | 475 ± 19 | 470 ± 17 |

1 mil = 10⁻³ inch; Supplier's names are shown in parenthesis of column 1

### EXAMPLE 2

This example was undertaken to determine the ground wall insulation tape that may be used to withstand the compaction. The ground wall insulation tapes are evaluated for AC electrical breakdown test before and after heat treatment at temperatures ranging from 300 to 600° C. for 30 minutes in nitrogen. The breakdown test was performed on the tape placed between two brass electrodes of 0.25 inch diameter. The voltage between the electrodes was increased till the breakdown of the tape/s. The breakdown voltage (BDV) reported herein corresponds to an average of at least 6 data points per specimen.

As in the case of magnet wire the major properties of ground wall insulation required for the present application are (i) high temperature withstand capability and (ii) the compressibility in the SMC medium. Several insulation tapes were identified for the preliminary testing and screening as shown in Table 3. The mica tapes (Samples 1 and 2) are made of muscovite mica paper backed with glass cloth. Silicon resin is used as the binder for making these tapes. In the case of Sample 3, the muscovite mica paper is backed with Kapton film (instead of glass cloth) as in the case of Samples 1 and 2. Similarly, the Sample 6 is made of phlogopite mica paper backed with glass cloth. The Samples 4 and 5 are prepared by sandwiching the glass cloth backed muscovite mica paper between two thin papers/films of Nomex or Mylar. The Sample 7, based on flouro (Teflon) polymer is found to exhibit good mechanical properties (e.g., tear resistance). The breakdown voltage of the all the tapes is measured for as-received condition and also after exposing the tapes to higher temperatures in nitrogen for 30 minutes. Table 3 below summarizes the results of various tapes that are evaluated.

TABLE 3

| | Thick. | BDV/mil | BDV-kV | BDV-kV |
|---|---|---|---|---|
| Sample Number | (mil) | (kV/mil) | (30° C.) | 600° C. |
| 1. Mica Tape: glass backed (VRI) | 4.82 ± 0.13 | 0.44 ± 0.06 | 2.1 ± 0.05 | 1.68 ± 0.11 |
| 2. Mica Tape: glass backed (L. Isola) | 4.86 ± 0.11 | 0.37 ± 0.03 | 1.8 ± 0.04 | 1.57 ± 0.07 |
| 3. Mica Tape: Kapton backed | 5.93 ± 0.12 | 1.28 ± 0.04 | 6.8 ± 0.2 | 4.3 ± 0.13 |
| (L. Isola) | | | | |
| 4. Nomex-Mica-Nomex Sheet (VRI) | 3.73 ± 0.45 | 1.21 ± 0.04 | 4.5 ± 0.15 | 3.5 ± 0.15 |
| 5. Mylar-Mica-Mylar tape (VRI) | 5.91 ± 0.14 | 1.01 ± 0.05 | 6.1 ± 0.1 | 2.8 ± 0.07 |
| 6. Phlogopite Mica tape (Crystal | 4.86 ± 0.1 | 0.34 ± 0.04 | 1.65 ± 0.1 | 1.5 ± 0.1 |
| Land) | | | | |
| 7. Fluoro Tape (W. L. Gore) | 1.38 ± 0.05 | 3.60 ± 0.15 | 4.97 ± 0.2 | 5.73 ± 0.2* |

*Result correspond to 400° C.
Supplier's names are shown in parenthesis of column 1

From the Table 3, it is seen that the Kapton backed (Sample3) and Mylar film—(Sample 5) and Nomex paper—(Sample 4) sandwiched mica tape displays better performance compared to other mica tapes. The Nomex sandwiched mica sheet (Sample 4) displayed, however, poor flexibility. The flexibility of the tapes is qualitatively judged by wrapping over a bundle of magnet wire. Poor flexibility results in the formation of the gaps between each layer, which is detrimental since the SMC material can penetrate through the gaps. Kapton-backed tape (Sample 3) displayed de-lamination at low temperatures (less than or equal to about 300° C.) as well as poor compression strength in SMC medium. However, Mylar sandwiched mica tape is found to display high flexibility and adequate breakdown voltage after the exposure to higher temperature (600° C). Similarly, the fluoro tape is found exhibit very high flexibility and superior breakdown properties up to 400° C. despite its low thickness (1.38 mils). However, the compressibility of the flouro tape was found to be very poor. The superior properties such as lower thickness, higher breakdown voltage and high temperature withstand capability (400° C.) makes the flouro tape suitable for the motors used at low temperatures. Similarly, Nomax sandwiched mica sheet is useful for the slot insulation/liner application in the conventional motors. Based on the above results, mylar film sandwiched mica glass (referred to as Isomica) may be used at elevated temperatures.

### EXAMPLE 3

This example was undertaken to determine the bobbin insulation system. Selected magnetic wires were subjected to coil/bobbin winding. Initially, 30 turns are wound using a winding machine. The bobbin was then wrapped (manually) with the ground wall insulation tape and subjected to curing at 130° C. for 3 hrs. The wrapping of the insulation tape was performed with 50% overlap in all the cases. The coil was then subjected to breakdown voltage (BDV) test, compressibility and heat treatment in nitrogen as discussed below.

The bobbin (wrapped with ground wall insulation tape) was placed in an appropriate die cavity and filled with SMC particulates. The bobbin was then subjected to compression by applying the pressure on the top punch of the die. The compressed sample was then ejected from the die and subjected to simple electrical tests: (i) continuity test between the two edges of the magnet wire (i.e., bobbin) and (ii) continuity test between the surface of the compressed bobbin (i.e., SMC) and the magnet wire of the bobbin (copper). In the former test, any open circuit indicates the magnet wire damage, whereas in the latter test, the continuity indicates the damage of bobbin insulation (ground wall and magnet wire insulation).

The samples that pass tests (i) and (ii) were subjected to heat treatment in a nitrogen environment for 30 minutes. The heat treatment was performed at temperatures of 300 to 600° C. The integrity of the ground wall insulation was evaluated at various stages (after compression and heat treatment) through breakdown test under AC and impulse (1.2/50 μs) condition.

The selected magnet wires (fused glass and PEI-PAI enameled) and the Mylar sandwiched mica-glass tapes were subjected to evaluation in bobbin form. The wound coil is then wrapped with Isomica tape and the wrapping is performed with 50% overlap. The bobbin is then subjected to curing at 130° C. in air for 2 hours. The cured bobbin is then placed in the die, followed by SMC power (iron powder) filling and subjected to compression at about 100 ksi (689 MPa) pressure. No visual damage is observed on the bobbin. The breakdown voltage of the ground wall insulation tape (i.e., wrapped on the bobbin), before and after compression in the SMC powder is shown in Table 4 below:

TABLE 4

| Condition | Breakdown Voltage (kV) |
|---|---|
| Before compression | 2.8 ± 0.07 |
| After compression | 1.6 ± 0.03 |

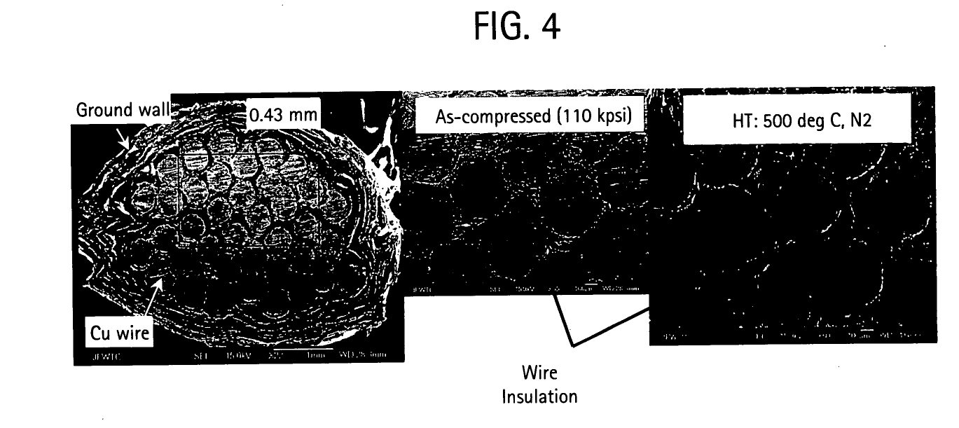

The results indicate that the ground wall insulation survives under compression in the SMC powder medium. The reduction in the BDV after compression is believed to be due to the edge effect where the pressure is believed to be very high due to non-uniformity. The cross section of the bobbin after compression in the SMC powder is evaluated using scanning electron microscope. The compressed samples are cut using diamond blade (ISOMET). Typical cross section of the compressed bobbin is shown in FIG. 4.

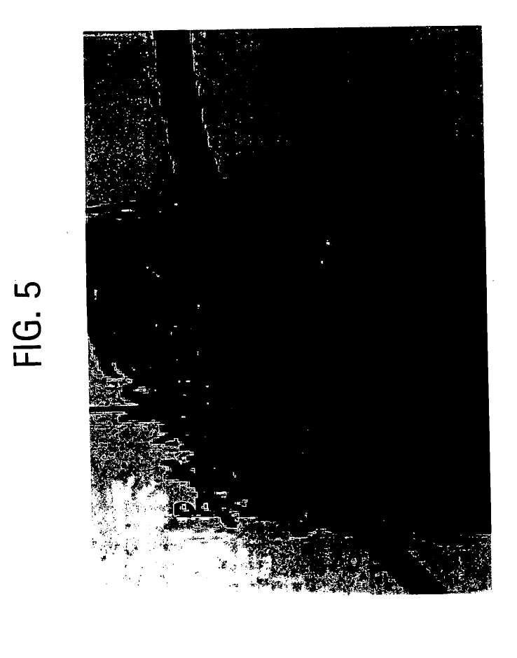

The micrographs of the bobbin cross section clearly indicates the ground wall insulation and magnet wire insulations are intact after compression in SMC powder and heat treatment. The magnetic properties such as permeability and core loss were found to be very much improved in the SMC materials made with flake articles as compared to iron powder particles. Hence, the compression of bobbin in SMC flake medium is also evaluated. As a first step, the selected magnet wire is been tested for the compressibility under flake medium. FIG. 5 shows the effect of flake compression (100 ksi (or 689 MPa)) on the fused glass magnet wire. It may be seen that the insulation is damaged significantly. Similar tests were conducted on several types of magnet wires, and in all the cases the insulation was damaged significantly. This result clearly indicates that the insulation may not survive compression in SMC flakes.

### EXAMPLE 4

This example was undertaken to determine whether the application of a coating to the ground wall insulation tape would enhance the ability of the insulation layer 20 to resist damage during the compaction of the ferromagnetic particles. A SILOX CE77 coating commercially available from Nippon Pelnox was evaluated in order to evaluate the flake-mitigation capability of the coating. Preliminary trials were conducted on the bobbins (without any ground wall insulation). The cross section of the bobbin subjected to 100 ksi (689 MPa) pressure when surrounded by iron flakes, indicates that the coating resists the flake penetration. The magnet wire is found to retain the continuity and the insulation strength.

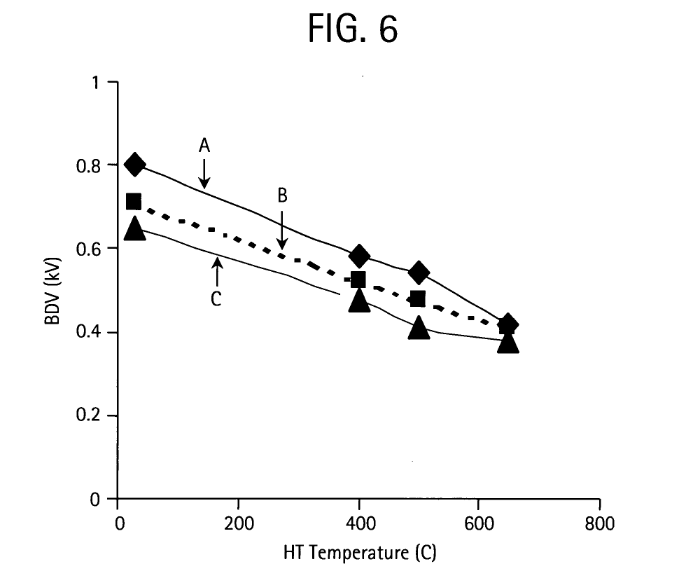

Three types of SILOX coating material were evaluated. The basic formulation of the three grades was the same. The variables among these grades are (i) filler particle size distribution and (ii) the pigment. In order to understand the thermal withstand capability, different SILOX materials made of 1mm thick plate were subjected to heat treatment in N₂ for 30min. at different temperatures. After cooling the samples, the breakdown voltages are determined. FIG. 6 shows the breakdown voltages of different SILOX grades as a function of heat treatment temperature. It may be seen from the FIG. 6 that the grade-A (identified based on the red color pigment) exhibits higher BDV compared to other two grades. Hence, grade-A SILOX material was chosen for further evaluation. In order to understand the superior performance of grade-A the comparative study was extended to the bobbin. The bobbin samples with SILOX coating were tested for BDV as shown in the Table 5 below.

TABLE 5

| Coating Grade | BDV (kV) |
|---|---|
| Silox A | 2.0 ± 0.10 |
| Silox B | 1.5 ± 0.21 |
| Silox C | 1.4 ± 0.11 |

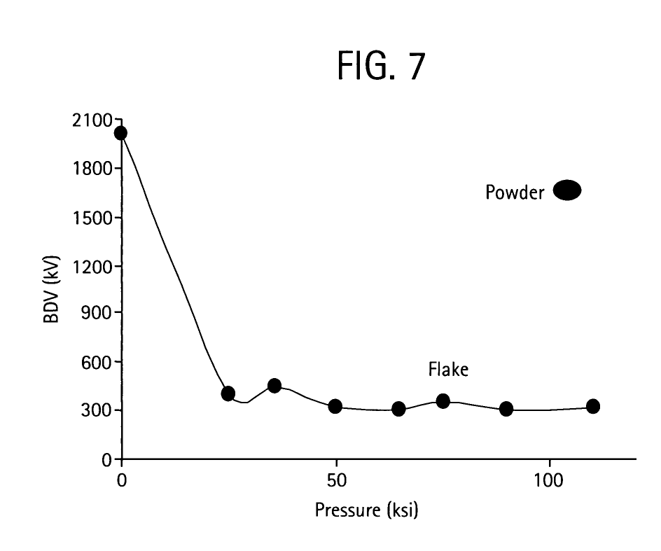

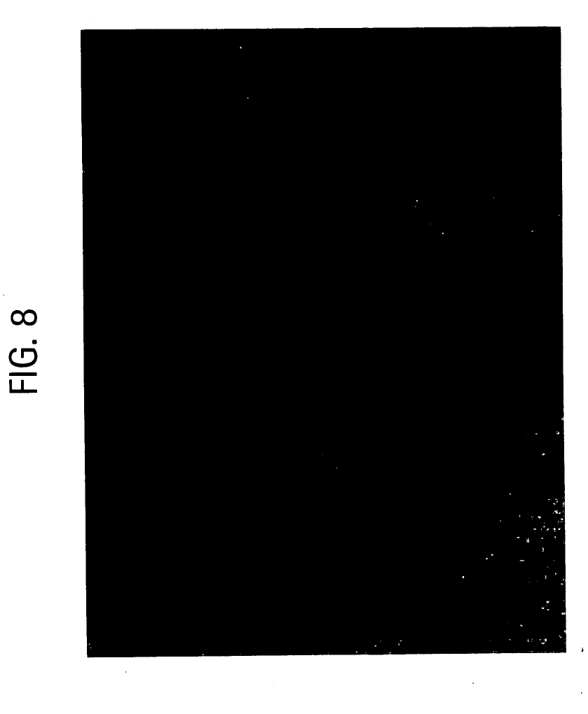

The bobbins consisting of fused glass wire, mica tape and coated with a layer of SILOX were then subjected to a compressibility (compaction) test when surrounded by ferromagnetic flakes. The breakdown voltage (BDV) as a function of pressure, shown in FIG. 7, indicates clearly that the insulation is damaged at a very low pressure of 20 ksi (138 MPa). The BDV of the bobbin, however, without SILOX coating displays higher BDV at 110 ksi (758 MPa) while being compacted in the SMC-powder (ferromagnetic particles). In order to understand the failure of insulation in flake medium, the samples were subjected to cross sectional analysis from which it was determined that the bobbin was deformed significantly though the magnet wires are bundled together by ground wall tape and SILOX coating. The deformation essentially results in sliding/pushing of SILOX coating towards center. The optical micrograph of the sample shown in FIG. 8 indicates that there is no damage to the magnet wire insulation. However, the thickness of the ground wall insulation is found to be non-uniform as evidenced in FIG. 8. The reduced and non-uniform ground wall insulation thickness indicates that the deformation of bobbin is the major cause for the lower breakdown voltage, observed after the bobbin compression in flake medium. In order to understand the insulation damages, after SMC flake compression, the bobbin is separated from the flakes for analysis. The analysis confirmed that ground wall insulation was damaged significantly. Besides, the magnet wires are also found to be damaged particularly at the ends. The damaged location of the bobbin is closer to the die wall during compression. The combination of the non-uniform pressure in the die and the bobbin deformation is found to be responsible for the insulation damages. In order to understand the deformation, a set of bobbin is subjected to deformation and elongation analysis. The deformation of the bobbin is estimated from the width of the bobbin using the following relation ship:

The elongation of the bobbin is estimated from the circumference of the bobbin before and after compression. The percentage deformation and elongation of the bobbin is estimated based on the following relationship:

$$Deformation ( \% ) = \frac{( Final width - Initial width )}{Initial width} \times 100$$

The deformation and elongation as a function of pressure, observed in flake medium is shown in the figures below:

$$Elongation ( \% ) = \frac{( Final Circumference - Initial Circumference )}{Initial Circumference} \times 100$$

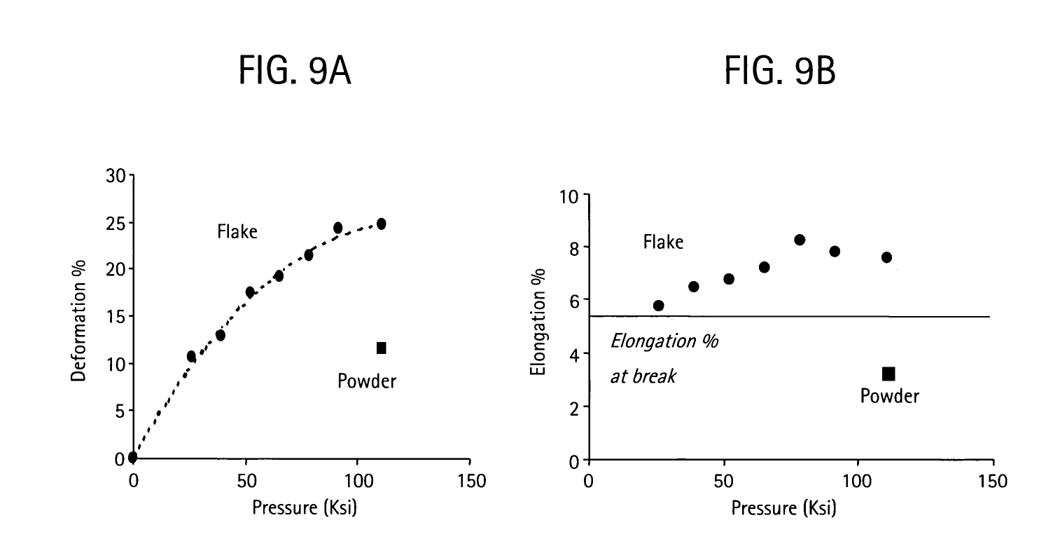

The results of the deformation and elongation can be seen in the FIG. 9. As can be seen in the graph that the deformation percentage increases with the increase of pressure. The extent of deformation i.e., about 25%, observed at 110 ksi (758 MPa) pressure, is believed to be high. Contrarily, the deformation of the bobbin in ferromagnetic particulate medium is about 10% at 110 ksi (758 MPa) pressure. The extent of elongation is found to be above 5% at the lower compaction pressure of 20 ksi (138 MPa). The breakage elongation percentage of the ground wall insulation tape as reported by the tape manufacturer (VRI) is about 5%. Based on the elongation behavior of the bobbin in flake compression and the breakage elongation percentage of the insulation tape, it was concluded that the insulation tape is damaged at compaction pressures above 20 ksi (138 MPa).

Cause and effect analysis was performed in relation to the bobbin deformation. The analysis revealed that the bobbin deformation are potentially caused by the major factors such as (a) flake flowability (b) SILOX coating thickness, (c) mechanical strength of insulation tape and (d) bobbin clearance from die wall. In order to understand the effect of each cause on the bobbin deformation was studied individually. The bobbin samples for these studies were prepared by using fused glass wire, Isomica tape and SILOX coating as detailed above.

### EXAMPLE 5

Based on the results detailed above the sample shape and process methods, die modification and compaction methodology were altered to establish a good method for evaluation and screening the insulation layer. Various parameters were evaluated such as (i) bobbin clearance (ii) flake flowability (iii) SILOX coating thickness (iv) tape strength (v) method of compaction. For these experiments bobbins (wires from the winding) having a cylindrical shape were used. The insulation tape was wrapped over the bobbin and subjected to SILOX coating as before. The samples thus prepared were subjected to compression in the presence of ferromagnetic particulates (flake medium).

In order to reduce damage to the ferromagnetic particulates that are in the form of flakes, a silicone lubricant was used to improve the flowability of the particulates.

The lubricants used in the present work include SF 5000, SF 350 and SF 100 resins (GE-Bayer silicone grades). The viscosity of these resins are 5000, 350 and 100 centipoise (cps), respectively. After compression the bobbins were subjected to electrical tests to evaluate the status of the insulation related to magnet wire and ground wall insulation. Out of 16 samples tested only 2 samples displayed no shorting and retention of magnet wire continuity after the compression. Besides, the BDV of these 2 samples was found to be less than 1 kV. Use of lubricants is found to wet the ground wall insulation leading to disintegration of the insulation. In other words, the insulation is softened due to the presence of lubricant such as silicone resin. The softening essentially leads to more damages on the insulation.

The coating such as SILOX is realized to be an important component as it mitigates the penetration of the flakes. Note that the coating thickness was varied from 0.2 to 1 mm. The bobbins possessing various SILOX coating thicknesses disposed upon the ground wall insulation were subjected to compression in the presence of the flakes. In general it was observed that those samples with 0.5 mm or less coating thickness displayed better results compared with those having a higher coating thickness. About 50% of the samples coated with SILOX coatings having 0.5 mm thickness were found to exhibit BDV around 1.5 kV. In the case of higher coating thickness (greater than or equal to about 0.5 mm thick) more than 90% of the samples failed during compression. The BDV of about 1.5 kV observed with thickness 0.5 mm or less is, however, not adequate as the BDV target is more than 2 kV.

In general the mechanical properties of the tape is directly related to the compression performance in the presence of the ferromagnetic flakes during the compaction process. Hence, various tapes, shown in Table 6 below, were tested for the withstand capability.

TABLE 6

| | | Elongation | |
|---|---|---|---|
| | | at Break | |
| Tape | Tensile (N/cm) | (% min) | Comments |
| Glass-Mica (VRI) | 40 | 5 | Flexible |
| Glass-Mica (L. Isola) | 50 | 5 | Flexible |
| ISOMICA (VRI)* | ˜100 | — | Flexible |
| Myoflex 2NC130 (VRI)** | 75 | 6 | Not flexible |
| Myoflex 2N*80 (VRI)** | 195 | 12.4 | Not flexible |

*Polyester film on both sides of glass-mica tape
**Nomex-semica-Nomex sheets
Supplier's names are shown in parenthesis of column 1

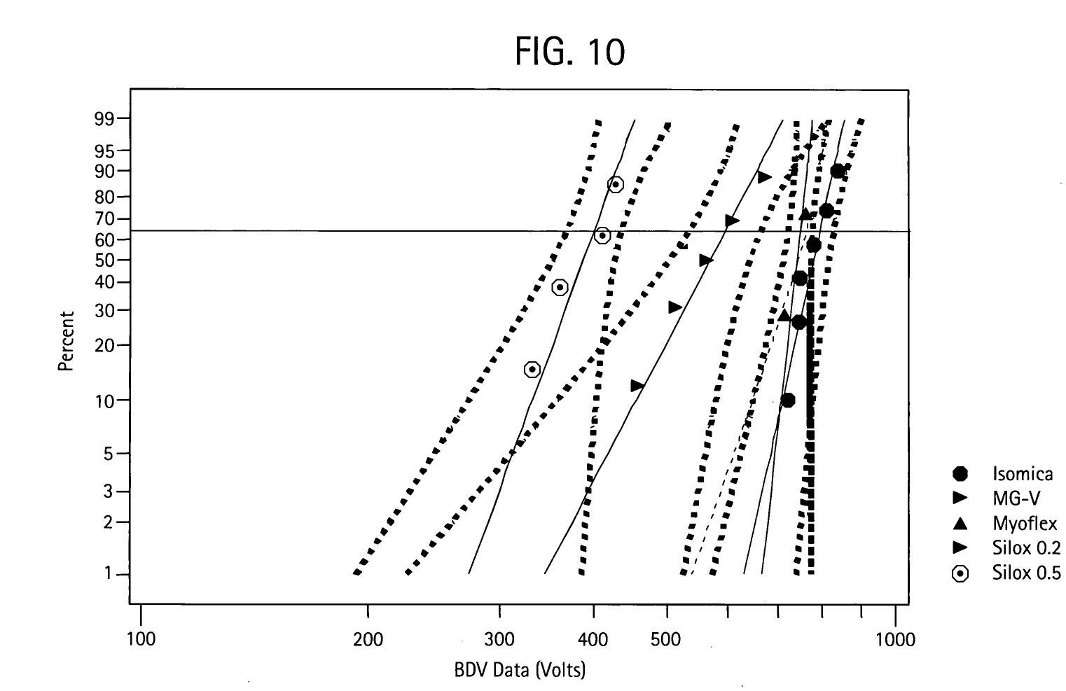

The bobbin samples with different insulation tapes were prepared as discussed in the above example. The SILOX coating thickness in all the samples are 0.5 mm thickness and the only variable is the type of insulation tape. The samples thus prepared are subjected to compression in the flake medium at 110 ksi (758 MPa) pressure. From Table 6, it may be seen that only around 50% of the samples survived (i.e., they displayed no shorting or discontinuity in the magnet wire) after the compression. In the case of myoflex-taped samples, the overlap portions of tape were damaged significantly. The BDV characteristics of selected type of samples are compared in the Weibull plot shown in FIG. 10. The SILOX coating thickness effect on the breakdown voltage of bobbin (without any tape) is also shown in FIG. 10. It may be seen from the Weibull plot that the BDV of the samples are less than or equal to about 1 kV, which is not acceptable for the present application. However, Isomica taped bobbin displays the highest BDV among all the tapes studied.

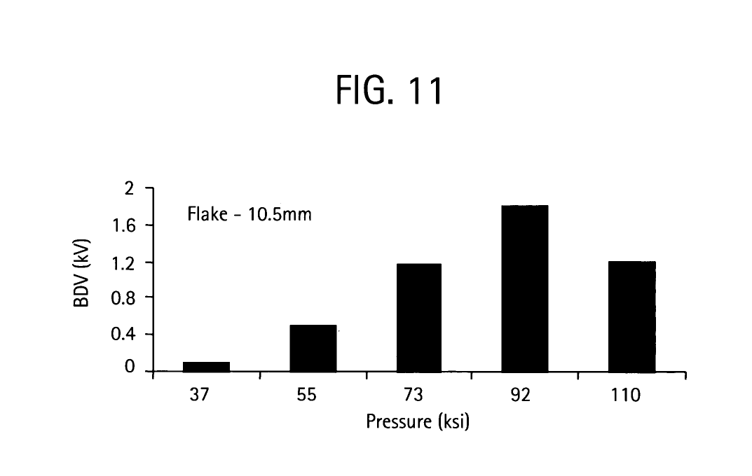

In order to determine the effect of compaction methods on the damage to the insulation various methods of compaction were attempted. It was generally found that the compaction involving 2-stages was found to be effective in the deformation control. In this method, initially, the flakes are compressed (pre-compaction) at various pressures to attain a slot of bobbin shape. The bobbin is then placed in the slot and filled with the flakes for final compression at 110 ksi (758 MPa) pressure. In order to optimize the pre-compaction condition, the samples are subjected to different pre-compaction pressures, ranging from 30 to 110 ksi (758 MPa), followed by a final compaction with the bobbin at 110 ksi pressure. The bar chart shown in FIG. 11 shows the breakdown voltage of the bobbin as a function of pre-compaction pressure. From the bar chart, it is seen that the samples pre-compacted at a pressure of about 90ksi 620 MPa) exhibit higher breakdown voltage of about 1.7 kV compared to the samples pre-compacted at other pressure levels.

Similar experiments/tests were conducted for SMC powders and shorter flake having a length of 5 mm to understand the pre-compaction pressure effect on the final BDV characteristics. Interestingly, in all the cases, the samples were subjected to a pre-compaction pressure of 90 ksi displayed higher breakdown voltage as summarized in Table 7. Note that the BDV of the samples compressed in powder and 5 mm flake displays are closer to each other (i.e., the BDV is greater than or equal to about 3 kV), whereas the samples compressed with longer flakes (10.5 mm) displays lower BDV. The observed results clearly indicate that the flowability of the SMC medium is the major factor that controls the BDV. Keeping this view in mind, the effect of flake mixture on the BDV is studied to optimize the compaction methodology.

TABLE 7

| SMC particles | Average breakdown voltage (kV) |
|---|---|
| Powder | 3.47 |
| Flake (10.5 mm) | 1.73 |
| Flake (5 mm) | 3.05 |

### EXAMPLE 6

In order to determine the effect of flake size, flakes of various sizes 3, 5 and 10.5 mm were selected for the mixture design of experiments (DOE). In the present work, D-optimal (Scheffe model) design is used.

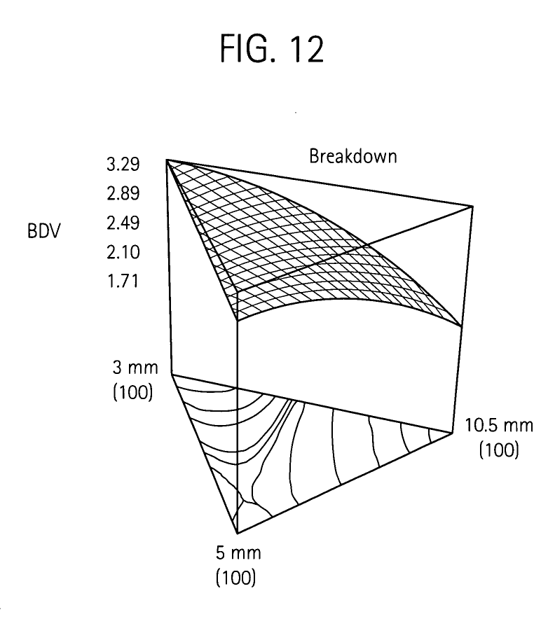

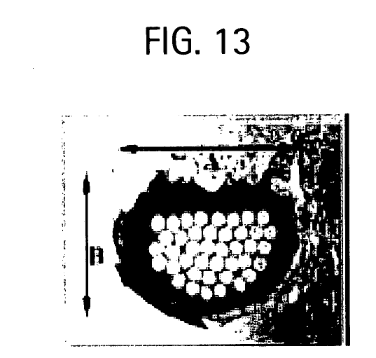

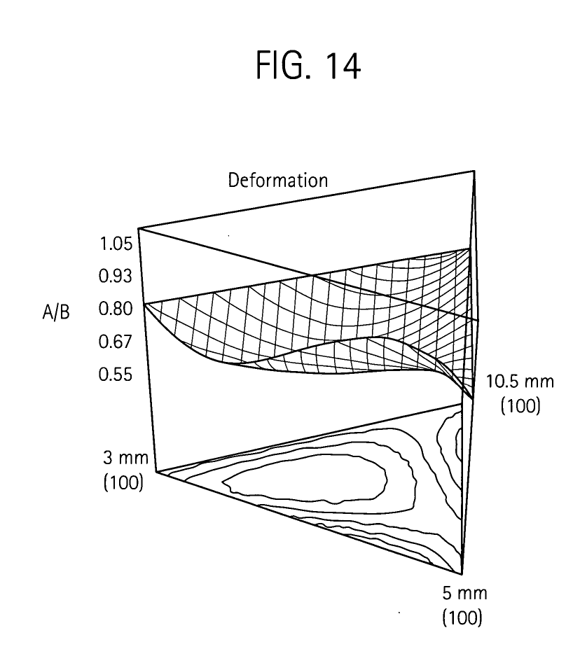

The responses studied for the DOE are breakdown voltage and deformation. The insulation system studied in the DOE is the combination of (i) fused glass magnet wire, (ii) Isomica tape as ground wall insulation and (iii) SILOX coating for mitigation of flake penetration. Bobbins prepared with this insulation system were used for the flake mixture study. The first DOE-response, i.e., breakdown voltage, is estimated for all the combination and plotted in FIG. 12. FIG. 12 shows that the breakdown voltage increases as the flake size reduces. The magnetic properties such as permeability are found to increase with the flake size. Hence, using the DOE, an optimum flake mixture is obtained using the following constraints: (i) 10.5 mm flake—minimum of 25 wt % and (ii) breakdown voltage greater than or equal to about 3000 volts. Under these constraints, the optimum flake mixture is obtained through the DOE tool is as follows: 3 mm flakes present in an amount of 72 wt % and 10.5 mm flakes present in an amount of 28 wt %. The optimum flake mixture was tested under the same conditions as detailed above and displayed that the BDV of the bobbin is above 3 kV. The second response—deformation is also studied. The second response (i.e., deformation) of the flake mixture DOE is also studied. The deformation of the bobbins is estimated as A/B ratio from A and B as indicated in the micrograph shown in FIG. 13. The DOE plot for the deformation is shown in the FIG. 14. Note that zero deformation corresponds to the ratio (A/B) of 1. Hence, lower the ratio higher the deformation. FIG. 14 reveals that the deformation ratio, observed within the range, does not show any predictable trend. From these experiments it can be seen that all the samples passed (i.e., no shorting or discontinuity in magnet wire observed) during with a two-stage compression; but the BDV values vary depending upon the length of flakes. The 3 millimeter flakes show a higher BDV than the other larger size flakes.

### EXAMPLE 7

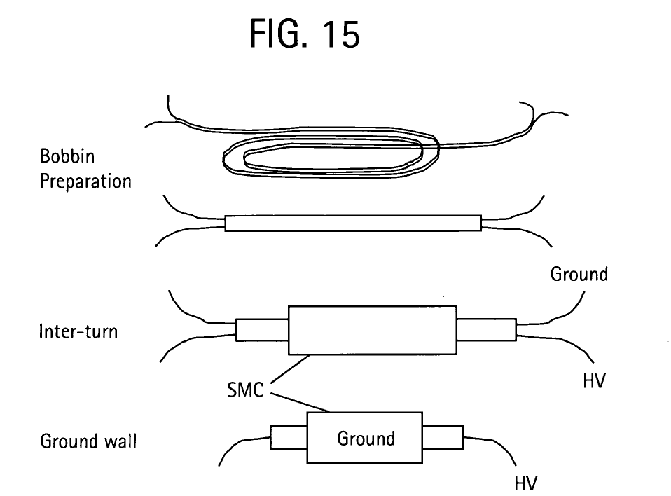

Since the insulation is found to survive during two-stage compaction in SMC flake medium a set of bobbins was prepared for a thorough analysis under alternating current (AC) and impulse conditions. This part of study was aimed at understanding the inter-turn insulation and ground wall insulation under compression followed by heat treatment in N₂. The bobbins are prepared by using two separate magnet wires for winding. This was done primarily to have the terminals for the measurement of inter-turn insulation. The schematic diagram of the bobbins is depicted in FIG. 15 and shows the terminals used for the electrical measurements. Four types of bobbins, (i) fused glass wire (having 3.8 and 3.0 mil thick insulation) and (ii) PEI_PAI enameled wire (1.6 and 0.8 mil thick insulation) were prepared for the electrical study. The ground wall insulation tape used in all the case was Isomica (VRI) tape. After wrapping ground wall tape (50% overlap and 2 layers) the bobbins were coated with SILOX (0.5 mm thick) and subjected to curing as discussed before. The samples thus prepared were subjected to two stage compression (a) pre-compression—90 ksi and (b) final compression—110 ksi) in SMC flake medium (3 mm length). Subsequently, the compressed samples were subjected to heat treatment in N₂ at various temperatures up to 500° C. for fused glass wire and 350° C. for PEI-PAI enameled wire. Initially, all the samples were subjected to screening tests as below:
(i) Inter-turn insulation: 50HZ AC up to 200 V
(ii) Ground wall insulation: Impulse (1.2/50 μs) up to 6000 V

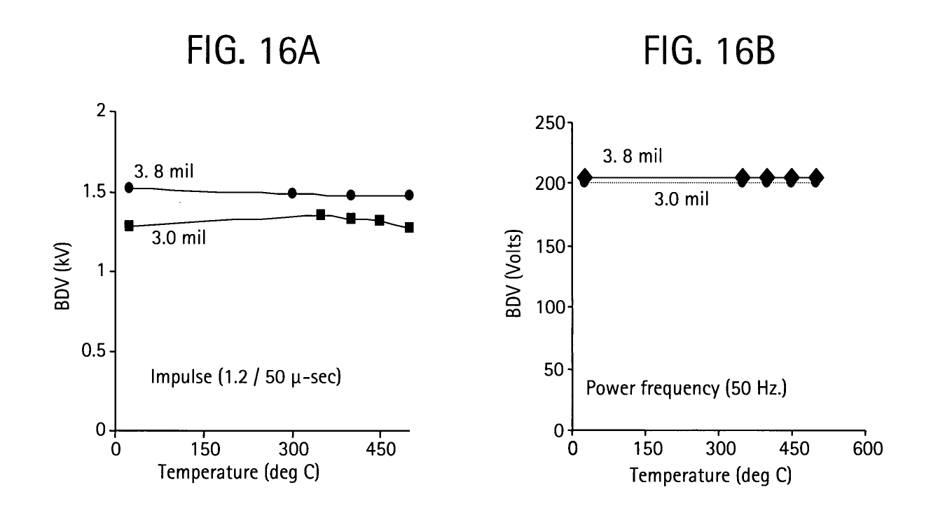

The selection of above voltage levels is based on the fact that the magnitude is adequate for the present application. All the present four types of samples, subjected to compression and heat treatment at various temperatures, had passed the above screening tests. After the screening tests, the samples were subjected to impulse test for inter-turn insulation and AC test for ground wall insulation till the failure level. In the case of inter-turn test, the impulse voltage was increased in steps of 100 volts till the failure level. The impulse-breakdown voltage of the inter-turn insulation of the fused glass wire of different thickness is shown in FIG. 16a. The power frequency test for the inter-turn insulation of fused glass wire is shown in FIG. 16b. From FIG. 16 it is seen from that the fused glass wires of 3 and 3.8 mil insulation thickness could withstand impulse voltage above 1000 volts up to 500° C. after compression in 3 mm flake at 110 ksi pressure.

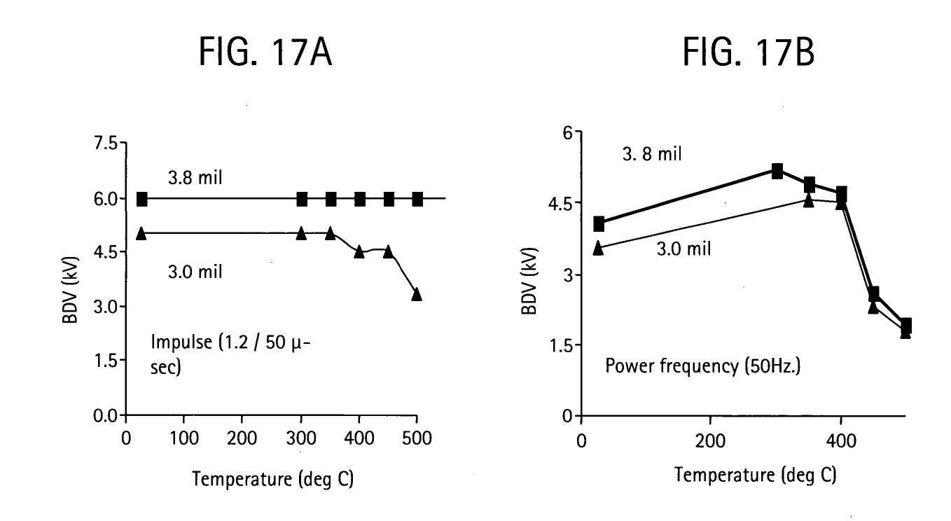

Similarly, the wires could withstand the power frequency voltage of 200 volts (minimum) indicating that these wires are suitable for the SMC molded motor applications. The ground wall insulation of the bobbins made of fused glass wires (3 and 3.8 mil insulation thickness) was also tested under impulse and power frequency voltages. FIG. 17 shows the ground wall insulation breakdown strength of the bobbin as a function of heat treatment temperature, after compression at 110 ksi in 3 mm flake medium. FIG. 17 reveals that the ground wall insulation (Isomica tape+SILOX coating) could withstand voltages of greater than or equal to about 3 kV (impulse) and greater than or equal to about 2 kV (AC) up to 500° C., indicating that the ground wall insulation survives under compression in flakes (3 mm) and heat treatment up to 500° C.

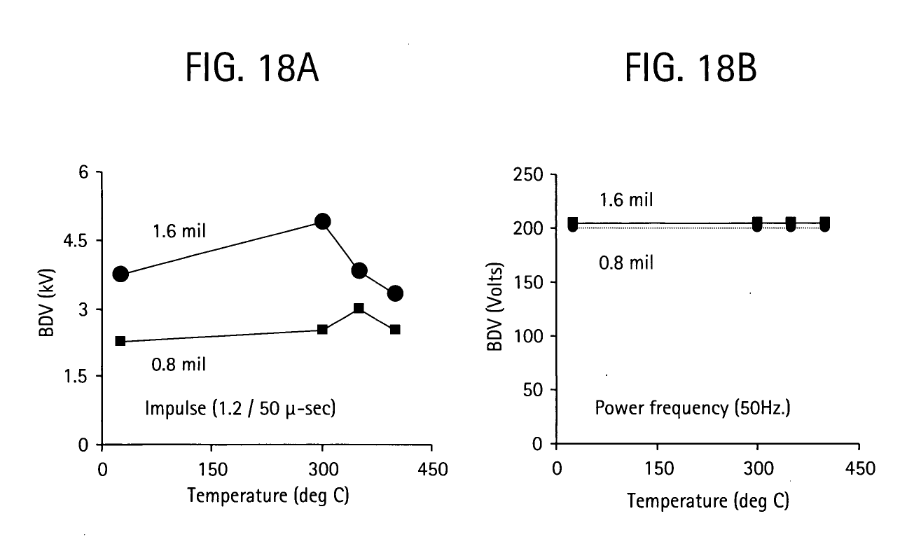

The bobbins that are prepared with PEI-PAI enamel wires of 1.6 and 0.8 mil insulation thickness and the ground insulation of Isomica tape and SILOX coating were also subjected to compression at 110 ksi and heat treatment at different elevated temperatures up to 350° C. These samples were subsequently evaluated for the breakdown voltages of inter-turn insulation and ground wall insulation as in the case of fused glass wire. FIG. 18 shows the breakdown strength of the inter-turn insulation as a function of heat treatment temperature. FIG. 18 reveals that the BDV of the inter-turn insulation (PEI-PAI) is above 1.5 kV (Impulse) and 200 V AC (minimum) up to 400° C. The electrical withstand level of the enamel wire (FIG. 18) is adequate for the present application.

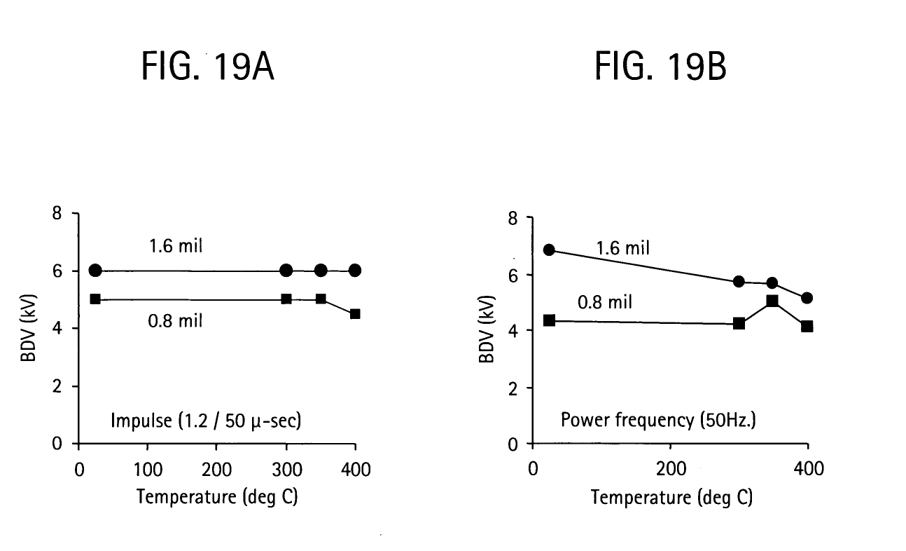

The BDV of the ground wall insulation (Isomica tape+SILOX coating), of the bobbins made of enamel wires (PEI-PAI) were also evaluated for the electrical breakdown under power frequency and impulse conditions. The breakdown voltages of the ground wall insulation as a function of heat treatment temperature is shown in FIG. 19. Note that the breakdown voltage of ground wall insulation is around 4 kV (AC) and greater than or equal to about 5 kV (impulse) up to the heat treatment temperature of 400° C. (FIG. 19). The BDV levels observed in the ground wall insulation are adequate for the SMC molded motor applications. Based on the electrical breakdown characteristics of the inter-turn and ground wall insulation results, the following insulation system is recommended:
(a) Fused glass wire (3 mil thick): Temperature up to 500° C. and compression up to 110 ksi
(b) PEI-PAI wire (0.8 mil thick): Temperature up to 400° C. and compression up to 110 ksi.

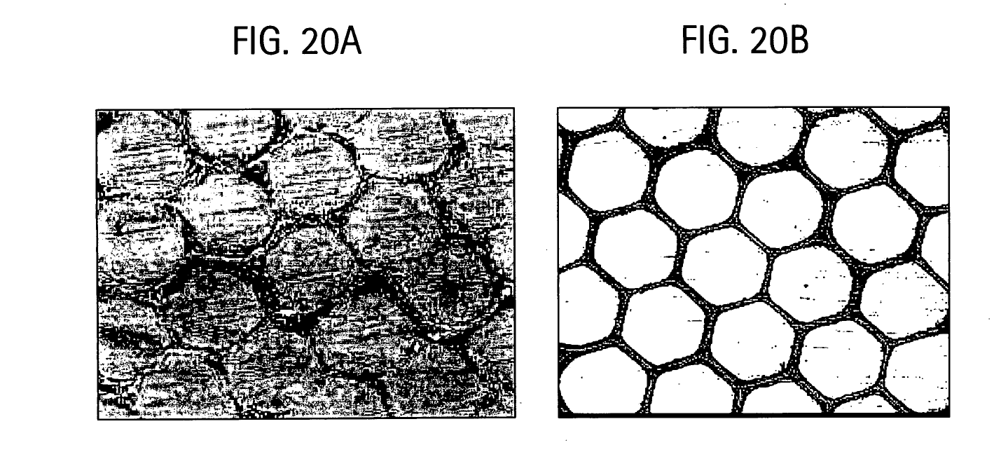

The two types of bobbin (fused glass and PEI-PAI enamel) are subjected to cross sectional analysis to understand the copper fill factor during compression. The compressed samples are sliced, using diamond blade (Isomet). The cross sectional surface of the sliced sections are analyzed using optical microscope. Micrographs of the fused glass- and enamel wire-bobbins are shown in FIG. 20.

From the micrograph, it is inferred that the enameled wire bobbin leads to the formation of hexagonal/honeycomb structure, an indication of high copper fill factor. Similar structure is not observed in the case of fused glass wire bobbin. The formation of hexagonal packing is essentially attributed to the deformation of the magnet wire. Though copper is known to deform at lower pressure the final structure such as the above (FIG. 20) is attributed to the characteristics of the insulation material. The hexagonal packing structure, observed in the PEI-PAI enamel wire bobbin, suggests that the enamel has good deformation characteristics. The absence of hexagonal structure, in the case of fused glass wire, indicates that the fused glass do not have adequate deformation characteristics. Note that glass is known to be brittle in nature. The copper fill factor for the bobbins made of fused glass and enameled wires, is estimated to be 78% and 85%, respectively (without ground wall insulation).

### EXAMPLE 8

In order to determine a more advantageous method of compaction (than the two stage compaction process) that will not damage the insulation, an attempt was made to understand the effect of axial compaction where the bobbin position is parallel to the direction in which the compaction force is applied. During compaction, the SMC medium is expected to flow along the surface (axial direction) of the bobbin. The number of turns of each bobbin is about 15 turns. The preliminary compaction (i.e., axial) was performed with the different SMC mediums such as powder and flakes (3 and 10.5 mm long respectively). The compression is performed at 100 ksi pressure in all the cases. After compression, each cavity bobbin is subjected breakdown tests under AC. Interestingly, all the 4 cavity bobbins survived (i.e., no shorting or discontinuity in the magnet wire) under axial compaction in SMC medium including 10.5 mm flakes. These preliminary results indicate that the axial compression may be a potential technique for the SMC molded motor manufacturing. The AC breakdown voltages of the above axial-compacted samples are compared in Table 8.

TABLE 8

| S. No. | Sample | Avg. |
|---|---|---|
| 1 | Powder: No Silox | 3.3 |
| 2 | Powder: No Silox | 2.3 |
| 3 | 3 mm flake: No Silox | 1.18 |
| 4 | 3 mm flake: Silox | 3.23 |
| 5 | 3 mm flake: Silox | 2.93 |
| 6 | 10.5 mm flake: Silox | 2.28 |
| 7 | 10.5 mm flake: Silox | 2.03 |

It may be seen (Table 8) that the bobbins compressed (axial) in SMC powder and 3 mm flakes display higher BDV (average) compared to that of 10.5 flakes. The observed trend is consistent with that observed in the samples compacted with the conventional die (i.e., compaction in the radial direction). In the case of 3 flake compression, the samples without SILOX coating results in very low BDV compared to that observed with SILOX coating. These results substantiate the fact that the SILOX coating plays an important role in the insulation protection. The significant variation in the BDV among the bobbins of 4 cavities (i.e., for a single compaction) may be attributed to the non-uniform flow of SMC material/stress during compaction. Hence, the die design and bobbins preparation requires appropriate modification to attain uniform results among the bobbins.

Based upon the aforementioned results it may be seen that fused glass wire insulation may be used advantageously for temperature up to 500° C. and PEI-PAI enameled wire up to 400° C. The insulation thickness of the former is about 3 mil (75 micrometers) and for the latter it is 1 mil (25 micrometers) is found to withstand the compression and high temperature. High copper fill factor is achievable in the case of enameled wire due to the fact that (i) the insulation thickness is lower and (ii) compaction results in hexagonal structure formation. Isomica tape (glass backed mica—sandwiched between mylar films) displays good performance under compression and at high temperatures. Use of SILOX like material coating plays vital role in mitigating the flake penetration and hence such coating is recommend for protecting the ground wall insulation such as Isomica tape. Axial compaction appears to be a potential technique for the manufacturing of SMC molded motors and advantageously shows a higher breakdown voltage after compaction.

In one embodiment, a bobbin wire coated with the insulation layer can withstand a breakdown voltage of greater than or equal to about 2, preferably greater than or equal to about 2.5 and more preferably greater than or equal to about 3 kV when compacted at a pressure of greater than or equal to about 70 ksi, preferably greater than or equal to about 80 ksi and more preferably greater than or equal to about 110 ksi. The insulation layer can advantageously withstand temperatures of greater than or equal to about 250, preferably greater than or equal to about 300, preferably greater than or equal to about 400, and more preferably greater than or equal to about 500° C. The insulation can also withstand pulses of greater than or equal to about 2 kV, preferably greater than or equal to about 3 kV, and more preferably greater than or equal to about 4 kV. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1-22. (canceled)

23. A method of manufacturing an article comprising:
disposing an electrically insulating backing upon a preformed winding of magnet wire;
disposing mica paper upon the electrically insulating backing; and
coating the mica paper with a polymeric resin.

24. The method of claim 23, wherein the electrically insulating backing is fibrous.

25. The method of claim 23, wherein the electrically insulating backing is wound around the preformed winding of magnet wire.

26. The method of claim 23, wherein the mica tape has a thickness of about 5 to about 150 micrometers.

27. The method of claim 23, wherein the mica paper is wound around the preformed winding of magnet wire with an overlap of about 10 to about 90%, wherein the overlap is the amount of area of any one given turn that is covered by a succeeding turn.

28. The method of claim 23, wherein the mica paper comprises an adhesive.

29. The method of claim 23, wherein the mica tape comprises a glass backing.

30. The method of claim 23, further comprising disposing a polymeric resinous film upon the electrically insulating backing.

31. The method of claim 23, wherein the polymeric resinous film is disposed upon the electrically insulating backing with a portion of the first surface in contact with the backing and wherein at least a portion of the surface opposed to the first surface is in contact with the mica paper.

32. The method of claim 23, wherein the coating comprising the polymeric resin is crosslinked.

33. The method of claim 23, wherein the coating comprising the polymeric resin is a cured silicone having a thickness of about 10 to about 2,000 μm.

34. The method of claim 33, wherein the coating is accomplished by dip coating, spray painting, electrostatic painting, brush painting or spin coating.

35. An article manufactured by the method of claim 23.

36. A method of manufacturing an article comprising:
disposing an electrically insulating backing upon a preformed winding of magnet wire;
disposing mica paper upon the electrically insulating backing;
coating the mica paper with a polymeric resin to form an insulated preformed winding of magnet wire;
compacting the insulated preformed winding of magnet and a plurality of ferromagnetic particles in a mold at a pressure of 250 to about 1500 MPa.

37. (canceled)

38. An article manufactured by the method of claim 36.
